(19) United States
(12) Patent Application Publication
(10) Pub. No.: US 2008/0063858 A1
(43) Pub. Date: Mar. 13, 2008

(54) MONO AND MULTI-LAYER LABELS

(75) Inventors: Gerald A. Hutchinson, Coto De Caza, CA (US); Said K. Farha, Pleasantville, NY (US)

Correspondence Address: KNOBBE MARTENS OLSON & BEAR LLP, 2040 MAIN STREET, FOURTEENTH FLOOR, IRVINE, CA, 92614, US

(73) Assignee: ADVANCED PLASTICS TECHNOLOGIES LUXEMBOURG S.A., Luxembourg (LU)

(21) Appl. No.: 11/841,939

(22) Filed: Aug. 20, 2007

Related U.S. Application Data
(63) Continuation of application No. 11/506,623, filed on Aug. 18, 2006.
(60) Provisional application No. 60/709,984, filed on Aug. 19, 2005.
(60) Provisional application No. 60/732,860, filed on Nov. 2, 2005.

(51) Int. Cl. B32B 5/16; B32B 37/12

(52) U.S. Cl. 428/323; 156/83

(57) ABSTRACT

Disclosed herein are sheets, labels, label stock, and articles comprising the same. Additionally disclosed are method for making the sheets, labels, label stock, and articles comprising the same. In some embodiments, the sheets, labels, and label stock comprise one or more layers, wherein at least one layer comprises microspheres. In some embodiments, the sheets, labels, and label stock comprise one or more layers of a foam material. In some embodiments, one or more layers comprise a cellulose material.

### CROSS-REFERENCE TO RELATED APPLICATIONS

This application is a continuation of U.S. patent application Ser. No. 11/506,623 filed Aug. 18, 2006, currently pending, which claims the priority benefit under 35 U.S.C. § 119(e) of the provisional applications 60/709,984, filed Aug. 19, 2005, and 60/732,860, filed Nov. 2, 2005, which are hereby incorporated by reference in their entireties.

### BACKGROUND OF THE INVENTION

1. Field of the Invention

Embodiments of the invention relate to articles comprising microspheres, and in some specific embodiments, labels and sheets comprising microspheres, and methods of making such articles, labels and sheets.

2. Description of the Related Technology

Thermal insulation of containers is increasingly important. Consumers often require that containers be kept at certain temperatures to enhance the taste and flavors of foodstuffs found within such packaging. For example, soft drinks consumed by the public are served chilled in a variety of packaging materials of choice for a majority of beverage applications. Consumption of the foodstuff within package usually results in the container and foodstuff absorbing heat from the surrounding environment of the container. Additionally, in the case of carbonated beverages, the beverage will go “flat” due to an increased loss in the carbon dioxide from the beverage once an opened package is exposed to the warmer temperatures. Similarly, certain foods and beverages are preferably served at a temperature warmer than ambient, and undergo an unacceptable cooling when exposed to a sufficiently low temperature. Thermally insulating labels on containers is one solution to reducing the heat conductivity of the container.

### SUMMARY OF THE INVENTION

Described herein are sheet, labels, label stock, and articles comprising the same. In some embodiments, the sheets are labels have one or more layers. In some embodiments, the sheets or labels are monolayered sheets or labels. In another embodiment, the sheets or label comprise multiple layers. In any given layer, the sheet or label may comprise one or more materials. In some embodiments these materials are functional materials. As such, the may provide one or more functions, including, but not limited to, a thermal insulation, gas barrier, moisture barrier, scuff or wear resistance, improved visual appearance, improved tactile properties, protection for the label, sheet, label stock or articles as described herein.

In some embodiments, a sheet comprises: a first layer adapted to receive printing; a second layer comprising foam material; and a third layer, the third layer having an adhesive outer surface adapted to adhere to a surface.

In some embodiments, a sheet or label comprises: a printable first layer; a second layer comprising foam material; and adhesive third layer. The thickness of the second layer is greater than the thickness of the first layer and the thickness of the third layer.

In some embodiments, a label attached to a container comprises: a first layer adapted to receive printing; a second layer comprising foam material; and a third layer, the third layer has an adhesive outer surface adhere to a surface of the container.

In some embodiments, a sheet or label comprises: an upper layer adapted to receive printing; an intermediate layer; and a lower layer, the lower layer has an adhesive outer surface adapted to adhere to a surface. In some embodiments, the intermediate layer comprises foam material.

In some embodiments, a sheet or label for packing is provided. The sheet or label comprises: an upper surface adapted to be printed upon; a lower surface adapted to adhere to a surface; and a body positioned between the upper surface and the lower surface, the body comprising foam material.

In another embodiment, the sheet or label for packing is provided. The label comprises: an upper surface adapted to be printed upon; a lower surface adapted to adhere to a surface; and at least one intermediate layer between the upper surface and the lower surface. The label comprises foam material.

In some embodiments, a sheet or label has an average density of about 0.4 g/cc, 0.5 g/cc, 0.6 g/cc, 0.7 g/cc, and ranges encompassing such densities. In some embodiments, the sheet can have an average thickness of about 10 mils, 15 mils, 20 mils, 22 mils, 24 mils, 28 mils, and ranges encompassing these thicknesses. In other embodiments, the sheet or label may have an average thickness of less than about 10 mils. In another embodiment, the sheet or label has an average thickness of less than about 8 mils. In one embodiment, the sheet or label has a standard paper label thickness. In another embodiment, the sheet or label may have a thickness that varies. In one particular embodiment, the thickness of the sheet or label may be varied according to methods and with apparatuses described herein.

In one preferred embodiment, the sheet or label comprises a first layer comprising microspheres. In some of these embodiments, the first layer comprises one or more carrier materials. In one embodiment, the carrier material comprises a foam material. In some embodiments, the foam material is polypropylene. In another embodiment, the carrier material comprises a cellulose material. In some embodiments, the cellulose material comprises pulp. In some embodiments, the carrier is paper.

In one embodiment, the sheet or label comprises at least one layer comprising paper. This layer may optionally comprise microspheres or other carrier materials. In on particular embodiments, at least one layer comprising paper is substantially free of microspheres. In another embodiment, a layer comprising microspheres may be coated on a layer comprising paper. In some embodiments, the layer comprising paper is a standard paper label.

In some embodiment, the sheet or label is configured to contact a container. In some embodiments, the sheet or label may be adhered to a container through a layer adapted to adhere to a container. In some embodiments, the sheet or label is self adhesive. In another embodiment, the sheet or label is adapted to adhere to itself after contacting a container. In one embodiment, the sheet or label comprises a layer configured to adhere to one or more article substrates selected from the group consisting of glass, paper, plastic, wood, and metal.

In one embodiment, a layer comprising microspheres has an average thickness of about 10 mils, 15 mils, 20 mils, 22 mils, 24 mils, 28 mils, and ranges encompassing these thicknesses. In one embodiment, at least some of the microspheres are collapsed microspheres and the layer comprising the microspheres has a thickness of less than about 10 mils. In one embodiment, the layer has an average thickness of between about 3 mils and about 8 mils. In some embodiments, the microspheres comprises mostly fully collapsed microspheres, partially expanded microspheres, or fully expanded microspheres.

In one embodiment, the sheet or label comprises one or more layers adapted to receive indicia. In one embodiment, a layer adapted to receive indicia is an outer layer. Methods of receiving indicia are further described herein.

In one embodiment, a sheet or label a first layer comprising microspheres, a second layer adapted to receive indicia, and a third layer adapted to adhere the sheet to an article. In one embodiment, the first layer is positioned between the second and third layer. In some embodiments, the second layer has a wall thickness less than about one half of a wall thickness of the first layer. In other embodiments, the second layer has a wall thickness less than about one quarter of a wall thickness of the first layer. In other embodiments, the second layer has a wall thickness less than about one tenth of a wall thickness of the first layer. In some of foregoing embodiments, one or more layers comprise a foam material. In some embodiments, the foam material comprises one or more foaming agents selected from chemical blowing agents and physical blowing agent.

In some embodiments, the layer comprising microspheres and/or a layer adapted to receive indicia is shrinkable. Materials, configurations, and methods suitable to cause shrinkage are further described herein.

In one embodiment, the layer comprising microspheres is an outer layer of the label or sheet. In another embodiment, the layer comprising microspheres is an inner layer of the label or sheet. In one embodiment, the layer comprising microspheres comprises more than about 60% by volume of the sheet. In one embodiment, the layer comprising microspheres is an intermediate layer between an inner layer and an outer layer.

In certain embodiments, the sheets or labels comprise mostly a foam material by weight. In some of these embodiments, the foam material is polypropylene.

In another embodiment, a sheet or label comprises an upper surface adapted to be printed upon; a lower surface adapted to adhere to an article substrate; and a body positioned between the upper surface and the lower surface. In some embodiments, the body comprises an expandable material. In some embodiments, the expandable material comprises microspheres. In certain embodiments, the expandable material further comprises a carrier material. Preferred carrier materials are further described herein.

In one embodiment, one or more of the upper or lower surfaces comprise a foam material. In one embodiment, the foam material is polypropylene. In one preferred embodiment, the upper surface comprises a water resistant barrier material.

In one embodiment, one or more layers, including the body, may be formed by an extrusion process. In another embodiment, one or more layers are coating layers. In some embodiment, a coating may be formed by a process selected from the group consisting of dip, spray, flow, and roller coating.

In one embodiment, the layer comprising microspheres, which includes the body, comprises more than about 60% by volume of the sheet or label. In some embodiments, the layer comprising microspheres comprises about 10, 15, 20, 25, 30, 35, 40, 45, 50, 55, 60, 65, 70, 75, 80, 85, 90, 95, and 100% volume of the sheet or label.

In one embodiment, a method of producing foamed label stock comprises providing a label stock. In some of the embodiments, the label stock may comprise one or more layers, wherein at least one layer comprises microspheres. In one preferred embodiment, label, sheets, or label stock may be heated in a manner configured to expand at least some of the microspheres. One preferred heat source is an IR radiation heater

In one embodiment, sheets may be formed into label stock by cutting and/or slicing of the sheets into strips of label stock. Alternatively, sheets may be formed into labels by cutting. In some embodiments, the label stock may be cut into labels.

In one embodiment, the step of heating the label stock comprises passing the label stock through a heating system configured to heat the label stock on one or more sides.

In another embodiment, a method may further comprise cooling the label stock decrease and/or discontinue the expansion of the microspheres. In one embodiment, the step of cooling the label stock comprises passing the label stock through one or more rollers. In one embodiment, at least one of the rollers has a temperature less than that which would cause further expansion of the microspheres. In some embodiments, the temperature is less than 120° C. In another embodiment, the temperature is less than 100° C. In one embodiment, the temperature is less than 60° C. In another embodiment, the temperature is less than 25° C.

In some embodiments, the method further comprises applying an aqueous solution or dispersion of a thermoplastic polymeric material to the surface of the label stock. The label stock may then be dried at a temperature that does not substantially cause the expansion of the microspheres to form a layer.

In some embodiments, the labels, label stock, or sheet may be printed. This process is further disclosed herein.

In one preferred embodiment, a method of forming a label comprises providing a label stock, wherein the label stock comprises paper, applying an aqueous solution or dispersion comprising an expandable material to the label stock, drying the solution or dispersion at a temperature that does not substantially cause expansion of the microspheres to form a layer on the label stock. In some embodiment, the label stock may be cut to produce one or more labels. In further embodiments, a method comprises applying the one or more labels to a container. In another embodiment, the method comprises printing or embossing the label. In one embodiment, the paper label receives indicia prior to applying the aqueous solution or dispersion. In one embodiment, the method comprises expanding the expandable material. In some embodiments, the expandable material is heated to produce a foam.

In some embodiments, one or more layers comprising microspheres may be coated on an article substrate. In one embodiment, a layer of microspheres may be coated as a base coat on the article substrate. Optionally, the layer may be printed on after coating and drying on the article substrate. Thereafter, the one or more layers comprising microspheres may be expanded to create a foam label. In another embodiment, a layer suitable for receiving indicia may be coated on the base layer of the article substrate. In this embodiment, the label may be printed prior to or after expansion of the microspheres.

In one embodiment, a method of producing a label or sheet comprises mixing an expandable material with one or more selected from cellulose material, paper, or pulp to produce a mixture. In some embodiments, the method further comprises forming a label from the mixture. The label may have configurations as described herein. In some embodiments, the label comprises at least one layer, the at least one layer comprising the expandable material and one or more selected from cellulose material, paper, or pulp. In some of these embodiments, the expandable material comprises microspheres.

### BRIEF DESCRIPTION OF THE DRAWINGS

FIG. 1 is a cross-sectional view of a sheet or label in accordance with one embodiment.

FIG. 2 is a cross-sectional view of a sheet or label in accordance with another embodiment.

FIG. 3 is a schematic view of a heating system according to one embodiment.

FIG. 4 is an embodiment of a container comprising a sheet.

### DETAILED DESCRIPTION OF THE PREFERRED EMBODIMENT

All patents and publications mentioned herein are hereby incorporated by reference in their entireties. Except as further described herein, certain embodiments, features, systems, devices, materials, methods and techniques described herein may, in some embodiments, be similar to any one or more of the embodiments, features, systems, devices, materials, methods and techniques described in U.S. Pat. Nos. 6,109,006; 6,808,820; 6,528,546; 6,312,641; 6,391,408; 6,352,426; 6,676,883; U.S. patent application Ser. Nos. 09/745,013 (Publication No. 2002-0100566); 10/168,496 (Publication No. 2003-0220036); 09/844,820 (2003-0031814); 10/090,471 (Publication No. 2003-0012904); 10/614,731 (Publication No. 2004-0071885), 11/108,607 (Publication No. 2006-0073298); 11/108,342 (Publication No. 2006-0065992), 11/108,345 (Publication No. 2006-0073294), 11/405,761, filed Apr. 17, 2006, and provisional application 60/709,984, filed Aug. 19, 2005, and 60/732,860, filed Nov. 2, 2005, which are hereby incorporated by reference herein in their entireties. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned patents and applications.

A. Sheets, Labels, and Label Stock

Described herein are sheets, labels, and label stock. Also described herein are articles, such as containers, which comprise such sheets or labels. Further described herein are methods for producing sheets and labels. Additionally, methods of producing articles comprising sheets or labels are also described.

As used herein, the term “sheet” is a broad term and is used in its ordinary meaning and includes, without limitation, a monolayer sheet, a multilayer sheet, laminates, and generally flat planar structures. Sheets can be formed by various processes, such as the extrusion process described above. Sheets can be used to form part of packaging.

As used herein, the term “label” is a broad term and is used in its ordinary meaning and includes, without limitation, a monolayer label, a multilayer label, or laminates. Indicia such as text, graphics, designs, pictures, trademarks, and the like may be printed on one or more layers of the label. In some embodiments, labels may be made from sheets. However, this is in no way intended to limit the scope of the labels, as described herein, to those made from the sheets as described herein.

As used herein, the term “label stock” is a broad term and is used in its ordinary meaning and includes without limitation a plurality of labels, rolls of labels, precut magazine stacks of labels, or label feed stock. In some embodiments, label stock may comprise one or more labels as further described herein. Label stock may also be cut into individual lengths to make labels. While many embodiments described herein apply to both sheets and/or labels, these embodiments also apply to label stock. Additional embodiments specifically relating to label feed stock are also disclosed.

In some embodiments, sheets or labels may be attached to one or more articles. In some embodiments, sheets or labels are attached to a container such as, but not limited to, a bottle, can, jar, pouch, or vile. The container can be a glass container, metal container, plastic container, or any other suitable packaging container. Such containers may or may not contain foodstuffs, as these embodiments are not solely limited packaging comprising consumer foods and liquids. In some particular embodiments, the containers are suitable for hot fill applications and carbonated soft drink applications. In some embodiments, articles include lightweight, dimensionally stable containers. In other embodiments, sheets or labels may be affixed to other articles comprising substrates. Such substrates may be made from plastics, glass, metal, paper, wood, and other organic substrates.

In some embodiments, the sheet or label may comprise one or more layers. Sheets or labels may comprise more than one material in each layer. In some embodiments, the one or more layers comprise one or more functional material. In some embodiments, the one or more layers comprise two or more functional materials. In some particular embodiments, a label or sheet comprises three or more layers, each layer comprising a different functional material.

In one preferred embodiment, the sheet or label comprises at least one layer comprising a polymeric material. In one preferred embodiment, the sheet or label comprises at least one layer comprising a foam material. In some embodiments, the foam material may be mixed with microspheres. In some embodiments, the sheet or label comprises one or more layers, wherein at least one layer comprises a foam and/or an expandable layer.

In another preferred embodiment, the sheet or label comprises at least one layer comprising a cellulose material, such as pulp and/or paper. As such, traditional labels made from paper material may also be used according to various embodiments. In some embodiments, a label comprising cellulose material may be coated with a solution or dispersion comprising an expandable material. In these embodiments, the expandable material may form one or more additional layers on the paper label. As such, in some of these embodiments, the original layer comprising paper does not comprise the foam material. However, in other embodiments, the layer comprising paper may absorb at least some of the expandable material and thus producing a layer comprising paper and the expandable material.

In some embodiments, the sheet or label comprises one or more layers, wherein at least one layer comprises an adhesive material. In other embodiments, the sheet or label comprises one or more layers, wherein at least one layer comprises a material suitable for receiving indicia. Other embodiments of sheets and layers may also comprise one or more layers comprising materials suitable for other purposes including, but not limited to, gas barrier materials, moisture barrier materials, glossy materials, materials that further enhance printability of one or more layers, or scuff and wear resistant materials. Some of these additional materials are further described herein.

Each layer may comprise one or more materials to achieve one or more functions. For example, in some embodiments, a layer comprising a foam material may also be suitable for receiving indicia. Similarly, the various layers and materials discussed herein, as well as other known equivalents for each such material or layer, can be mixed and matched by one of ordinary skill in this art to achieve sheets or labels in accordance with principles described herein. Although certain embodiments and examples of certain configurations are described herein, it will be understood by those skilled in the art that the invention extends beyond the specifically disclosed embodiments to other alternative embodiments and/or uses and obvious modifications and equivalents thereof.

1. Foam and Expandable Layers

As used herein, the term “foam material” is a broad term and is used in accordance with its ordinary meaning and includes without limitation a material that is capable of forming foam or a material that has been partially or fully foamed. It may also include, without limitation, a foaming agent, a mixture of foaming agent and a binder or carrier material, an expandable cellular material, and/or a material having voids. The terms “foam material” and “expandable material” are used interchangeably herein. Preferred foam materials may exhibit one or more physical characteristics that improve the thermal and/or structural characteristics of articles (e.g., containers) and may enable the preferred embodiments to be able to withstand processing and physical stresses typically experienced by containers. In one embodiment, the foam material provides structural support to the container. In another embodiment, the foam material forms a protective layer that can reduce damage to the container during processing. For example, the foam material can provide abrasion resistance which can reduce damage to the container during transport. In some embodiments, the foam also provides abrasion resistance to the label on a container. In one embodiment, a protective layer of foam may increase the shock or impact resistance of the container and thus prevent or reduce breakage of the container. Furthermore, in another embodiment foam can provide a comfortable gripping surface and/or enhance the aesthetics or appeal of the container.

In particular embodiments, the sheet or label comprises one or more layers, wherein at least one layer comprises an expandable material. In one embodiment, the expandable material comprises a carrier material and a foaming agent. In some nonlimiting embodiments, the carrier material is preferably a material that can be mixed with the microspheres to form an expandable material. In one embodiment, the foaming agent comprises microspheres that expand when heated and cooperate with the carrier material to produce foam. In one arrangement, the foaming agent comprises EXPANCEL® microspheres. These materials are further described herein.

In preferred embodiments, the expandable material has insulating properties to inhibit heat transfer through the walls of a container comprising the sheet or label. The expandable material can therefore be used to maintain the temperature of food, fluids, or the like. In one embodiment, when liquid is in the container, the expandable material of the container reduces heat transfer between liquid within the container and the environment surrounding the container. In one arrangement, the container can hold a chilled liquid and the expandable material of the container is a thermal barrier that inhibits heat transfer from the environment to the chilled fluid. Alternatively, a heated liquid can be within the container and the expandable material of the container is a thermal barrier that reduces heat transfer from the liquid to the environment surrounding the container. Although use in connection with food and beverages is one preferred use, these containers may also be used with non-food items.

In one embodiment, one or more layers of the sheet or label comprise expandable structures (e.g., microspheres) that can be expanded and cooperate with the carrier material to produce foam. For example, the expandable material can be thermoplastic microspheres, such as EXPANCELL® microspheres sold by Akzo Nobel. In one embodiment, microspheres can be thermoplastic hollow spheres comprising thermoplastic shells that encapsulate gas. Preferably, when the microspheres are heated, the thermoplastic shell softens and the gas increases its pressure causing the expansion of the microspheres from an initial volume to an expanded volume. The expanded microspheres and at least a portion of the carrier material can form the foam portion of the labels and sheets described herein.

The expandable material can form a layer that comprises a single material (e.g., a generally homogenous mixture of the foaming agent and the carrier material), a mix or blend of materials, a matrix formed of two or more materials, two or more layers, or a plurality of microlayers (lamellae) preferably including at least two different materials. Alternatively, the microspheres can be any other suitable controllably expandable material. For example, the microspheres can be structures comprising materials that can produce gas within or from the structures. In one embodiment, the microspheres are hollow structures containing chemicals which produce or contain gas wherein an increase in gas pressure causes the structures to expand and/or burst. In another embodiment, the microspheres are structures made from and/or containing one or more materials which decompose or react to produce gas thereby expanding and/or bursting the microspheres. Optionally, the microsphere may be generally solid structures. Optionally, the microspheres can be shells filled with solids, liquids, and/or gases.

The microspheres can have any configuration and shape suitable for forming foam. For example, the microspheres can be generally spherical. Optionally, the microspheres can be elongated or oblique spheroids. Optionally, the microspheres can comprise any gas or blends of gases suitable for expanding the microspheres. In one embodiment, the gas can comprise an inert gas, such as nitrogen. In one embodiment, the gas is generally non-flammable. However, in certain embodiments non-inert gas and/or flammable gas can fill the shells of the microspheres.

Although some preferred embodiments contain microspheres that generally do not break or burst, other embodiments comprise microspheres that may break, burst, fracture, and/or the like. Optionally, a portion of the microspheres may break while the remaining portion of the microspheres do not break. In some embodiments up to about 0.5%, 1%, 2%, 3%, 4%, 5%, 10%, 20%, 30%, 40%, 50%, 60% 70%, 80%, 90% by weight of microspheres, and ranges encompassing these amounts, break. In one embodiment, for example, a portion of the microspheres may burst and/or fracture when they are expanded.

The microspheres can be formed of any material suitable for causing expansion. In one embodiment, the microspheres can have a shell comprising a polymer, resin, thermoplastic, thermoset, or the like as described herein. The microsphere shell may comprise a single material or a blend of two or more different materials. For example, the microspheres can have an outer shell comprising ethylene vinyl acetate (“EVA”), polyethylene terephthalate (“PET”), polyamides (e.g. Nylon 6 and Nylon 66) polyethylene terephthalate glycol (PETG), PEN, PET copolymers, and combinations thereof. In one embodiment a PET copolymer comprises CHDM comonomer at a level between what is commonly called PETG and PET. In another embodiment, comonomers such as DEG and IPA are added to PET to form miscrosphere shells. The appropriate combination of material type, size, and inner gas can be selected to achieve the desired expansion of the microspheres.

In one embodiment, the microspheres comprise shells formed of a high temperature material (e.g., PETG or similar material) that is capable of expanding when subject to high temperatures, preferably without causing the microspheres to burst. If the microspheres have a shell made of low temperature material (e.g., as EVA), the microspheres may break when subjected to high temperatures that are suitable for processing certain carrier materials (e.g., PET or polypropylene having a high melt point). In some circumstances, for example, EXPANCEL® microspheres may be break when processed at relatively high temperatures. Advantageously, mid or high temperature microspheres can be used with a carrier material having a relatively high melt point to produce controllably, expandable foam material without breaking the microspheres. For example, microspheres can comprise a mid temperature material (e.g., PETG) or a high temperature material (e.g., acrylonitrile) and may be suitable for relatively high temperature applications. Thus, a blowing agent for foaming polymers can be selected based on the processing temperatures employed.

In some embodiments, the foaming agent comprises microspheres that expand when heated and cooperate with a carrier material to produce foam. In some embodiments, the carrier material can be a thermoplastic or thermosetting material, such as ethylene acrylic acid (“EAA”), ethylene ethyl acrylate (“EEA”), ethylene vinyl acetate (“EVA”), linear low density polyethylene (“LLDPE”), CHDM (cyclohexane dimethanol) modified polyethylene terephthalate (PETG), poly(hydroxyamino ethers) (“PHAE”), polyethylene terephthalate (“PET”), polyethylene (“PE”), polypropylene (“PP”), polystyrene (“PS”), cellulose material, pulp, paper, mixtures thereof, and the like. Other preferred carrier materials include, but are not limited to, an acrylic or styrene-butadiene latex polymer or copolymer, or combinations thereof.

In some embodiments, the carriers include binders, polymers, or other materials used in a paper forming process. Where labels or sheets comprise paper and microspheres, the microspheres may be added with a suitable carrier during the paper manufacturing process. In some embodiments, the carriers may also enhance certain functions of the label. For example, the adhesion of the label, sheet, or laminate (some of these include paper) to an article substrate may be improved through the use of certain polymeric materials including, but not limited to, polypropylene. In other embodiments, one or more of polyesters, polyolefins such as polypropylene or polyethylene (or copolymers thereof), or phenoxy-type thermoplastics may be used as a carrier material.

In some embodiments, polymeric thermoplastic open cell or closed cell foams may be used. In some embodiments, the closed cell foams generally have at least about 5,000 closed cells per cubic inch (in³), about 305 closed cells per cubic centimeter (cm³), and less than about 250,000 closed cells per in³, from about 305 to about 6,100 closed cells per cm³, more preferably, from about 25,000 to about 75,000 closed cells per in³, from about 1,525 to about 4,575 closed cells per cm³, and, most preferably, from about 40,000 to about 60,000 closed cells per in³, from about 2,440 to about 3,660 closed cells per cm³. In some embodiments, the foam has a thickness of at least about 0.25 mm (about 0.01 inch). In other embodiments, the foams has a thickness of about 1 to about 4 mm (about 0.04 to about 0.16 inch).

In some embodiments, the foam is a polypropylene microfoam formed in a flash solution process, such as that disclosed in U.S. Pat. Nos. 3,584,090, 3,637,458, and 3,787,543 to Parrish, the contents of which are incorporated herein in their entirety by reference. The process essentially comprises preparing a solution of a film forming polymer in an organic solvent having a boiling point significantly lower than the melting point of the polymer. The solution is extruded, and a closed cell microfoam of the polymer is produced as the pressure on the solution is rapidly reduced as the solution exits the extruder. The solvent flashes into a gas, and the polymer foams and solidifies. One nonlimiting polypropylene microfoam insulation material is MICROFOAM®, available commercially from Pactiv Corporation, Lake Forest, Ill. MICROFOAM® is a foam having approximately 50,000 closed cells per in³, about 3,050 closed cells per cm³, and is available in several thicknesses, including 1/32 inch, 0.03125 inch (about 0.8 mm), 1/16 inch, 0.0625 inch (about 1.5 mm), and ⅛ inch, 0.125 inch (3.175 mm). Such a polypropylene microfoam, as with other foams, can be used alone or in combination, such as by lamination and coextrusion, with conventional label materials to form a label.

As foams, such as MICROFOAM®, are effective insulators, packages having a foam label in accordance with the invention stay colder or warmer for longer periods of time than do packages having prior art labels. Moreover, some polypropylene microfoam materials have a lower density and, thus, weight as compared to polyethylene or PET foams, and are more flexible, facilitating handling and application. In one embodiment, a polypropylene base allows the material to readily accept labels and tape for laminated structures and enables the adhesives to stick better.

In some embodiments, polymeric thermoplastic closed cell foams may also be blown with physical gaseous foaming and blowing agents, i.e., gases or low boiling point liquids, or by decomposing chemical foaming and blowing agents. The physical foaming agents include, but are not limited to, inert gases, such as nitrogen and carbon dioxide, hydrocarbons containing 3 to 5 carbon atoms, such as the isomers of the aliphatic hydrocarbons propane, butane, and pentane, and chlorinated hydrocarbons, such as methylene chloride, and the recently mandated “ozone-safe” replacements for banned chlorofluorocarbons, such as trichlorofluoromethane and dichlorodifluoromethane. Physical blowing agents are typically dissolved or dispersed in a liquefied plastic or melt polymer under pressure, either rapidly expanding or flashing into the gaseous state and rapidly expanding as the pressure is released, thereby forming the cellular structure in the polymer, which rapidly cools and solidifies as the desired foam. In contrast, chemical blowing agents decompose at elevated temperatures releasing an inert gas. Chemical blowing agents may be conventional diazo blowing agents, which, on decomposition, yield nitrogen. Chemical blowing agents useful in forming foams useful in the invention include, but are not limited to, organic and inorganic bicarbonates and oxylates, azo-chemicals, hydroxides, and amine nitrates. The chemical blowing agent is typically mixed with the thermoplastic materials in a process known in the art, such as mixing the chemical blowing agents with pellets or powders of the thermoplastic polymeric material, and introducing the blended material into an extruder inlet. The gas released when the blowing agent decomposes as a result of the heat in the extruder then forms the cellular structure in the resulting foam in the manner described above for physical blowing agents.

Other materials useful for certain labels or sheets include, but are not limited to, foams of the type described herein that are co-extruded with thermoplastic polymeric films that comprise a layer of the foam and a layer of the polymeric film material onto which indicia may be printed. Such co-extrusion and methods are known in the art.

In some embodiments polymers that have been grafted or modified may be used. In one embodiment polypropylene or other polymers may be grafted or modified with polar groups including, but not limited to, maleic anhydride, glycidyl methacrylate, acryl methacrylate and/or similar compounds to improve adhesion. In other embodiments polypropylene also refers to clarified polypropylene. As used herein, the term “clarified polypropylene” is a broad term and is used in accordance with its ordinary meaning and may include, without limitation, a polypropylene that includes nucleation inhibitors and/or clarifying additives. Clarified polypropylene is a generally transparent material as compared to the homopolymer or block copolymer of polypropylene. The inclusion of nucleation inhibitors helps prevent and/or reduce crystallinity, which contributes to the haziness of polypropylene, within the polypropylene. Clarified polypropylene may be purchased from various sources such as Dow Chemical Co. Alternatively, nucleation inhibitors may be added to polypropylene. One suitable source of nucleation inhibitor additives is Schulman.

Optionally, the materials may comprise microstructures such as microlayers, microspheres, and combinations thereof. In certain embodiments preferred materials may be virgin, pre-consumer, post-consumer, regrind, recycled, and/or combinations thereof.

2. Layer Capable of Receiving Indicia or Embossing

In some embodiments, the sheet may optionally comprise one or more layers that have received or are configured to receive indicia. As used herein, the term “indicia” is a broad term and is used in accordance with its ordinary meaning, and includes, without limitation, Indicia such as text, graphics, designs, pictures, trademarks. Indicia may be printed on any layer of the label or sheet and may be printed in a normal or inverse direction. In some embodiments, at least one layer comprising expandable material may be suitable for receiving indicia. In another embodiment, a layer configured to receive indicia may be an inner layer or an outer layer of the label or sheet. In some embodiments, a layer of suitable receiving indicia may be adjacent to a layer comprising expandable material. In some embodiments, the thermal insulating layer comprising microspheres is printed and an additional printable layer may be unnecessary.

Some preferred materials for receiving printable material include polyolefins, such as polypropylene and/or polyethylene. In some embodiments, the material comprises oriented polypropylene. In some particular embodiments, such materials are capable of receiving high definition color and images. In another embodiment, the material includes one or more cellulose materials, such as pulp or paper, which is capable of receiving indicia. In some embodiments, a sheet or label comprises at least one layer comprising one or more polyolefin. In preferred embodiments, such materials provide a surface which may receive high definition color and images. In some embodiments, print or graphics or reverse print or graphics may be applied to the layer suitable for receiving indicia.

In some embodiments, the label or sheet comprise one or more layer, wherein at least one layer is configured to receiving an embossment. In some embodiments, foam materials may be selectively foamed to produce an embossment on the sheet or label. Other suitable materials and layers configured to receive an embossment will be apparent to those skilled in the art.

3. Adhesive Layers

In certain embodiments, the sheet or label may be affixed to the article through any means. In some embodiments, one or more layers can be configured to contact an article. In some embodiments, one or more layers may comprise a material suitable for adhering the label or sheet to a container. In one embodiment, the sheet or label may be configured to adhere to itself. As noted above, certain adhesive layers may also have other functionalities.

One or more additives can be used to form an adhesive layer to achieve appropriate adhesive properties for the sheet or label. For example, an adhesive additive can be added to a polymer to form a material with adhesive properties. In some embodiments, a thermoplastic polymer is suitable for forming an adhesive layer. In one particular embodiment, the thermoplastic polymer is polypropylene. In this embodiment, the polypropylene can form a thermal barrier that further reduces heat transfer through the sheet. Alternatively, other materials, such as a polyester (e.g. PET), can be used to form the adhesive layer. A person having ordinary skill in the art will understand the specific combination of materials to form an adhesive layer may vary with the desired substrate to which the sheet or label is to be applied. As such, sheets or labels can be configured to be self-adhesive.

In some embodiments, certain adhesion materials may be added to one or more layers of an article substrate. In other embodiments, one or more layers comprises an adhesion material. Thus, as described herein, embodiments may include barrier layers comprising adhesion materials. In other embodiments, tie layers may comprise adhesion materials.

In some preferred embodiments, a polyolefin layer is used as an adhesion layer and/or a barrier layer. In some embodiments, one or more layers may comprise a modified polyolefin composition. In embodiments, an ethylene or propylene homopolymer or copolymer is used as material for an adhesion layer. In one embodiment polypropylene or other polymers may be grafted or modified with polar groups including, but not limited to, maleic anhydride, glycidyl methacrylate, acryl methacrylate and/or similar compounds to improve adhesion. In preferred embodiments, maleic anhydride modified polypropylene homopolymer or maleic anhydride modified polypropylene copolymer can also be used. As used herein, “PPMA” is an acronym for both maleic anhydride modified polypropylene homopolymer and copolymer. As used herein, “PEMA” is an acronym for both maleic anhydride modified polyethylene homopolymer and copolymer. These materials may be interblended with other functional materials to aid in the adhesion of these layers to each other or the article substrate material. Alternatively, the materials can be applied as tie layers which adhere the substrate and/or other layers of the sheet or label. In some embodiments, blends of polypropylene and PPMA are used. In some embodiments, PPMA is about 20 to about 80 wt % based on the total weight of the polypropylene and PPMA.

In other embodiments polypropylene also refers to clarified polypropylene. As used herein, the term “clarified polypropylene” is a broad term and is used in accordance with its ordinary meaning and may include, without limitation, a polypropylene that includes nucleation inhibitors and/or clarifying additives. Clarified polypropylene is a generally transparent material as compared to the homopolymer or block copolymer of polypropylene. The inclusion of nucleation inhibitors can help prevent and/or reduce crystallinity or the effects of crystallinity, which contributes to the haziness of polypropylene, within the polypropylene or other material to which they are added. Some clarifiers work not so much by reducing total crystallinity as by reducing the size of the crystalline domains and/or inducing the formation of numerous small domains as opposed to the larger domain sizes that can be formed in the absence of a clarifier. Clarified polypropylene may be purchased from various sources such as Dow Chemical Co. Alternatively, nucleation inhibitors may be added to polypropylene or other materials. One suitable source of nucleation inhibitor additives is Schulman.

In some embodiments, Phenoxy-type Thermoplastics may be used together with other layers, whether these are tie layers or barrier layers. For example, a PHAE may be added to one or more layers to increase adhesion between the article substrate material and/or other layers of the sheet or label. Other hydroxyl functionalized epoxy resins can also be used as gas barrier materials and/or adhesion materials.

In some embodiments, an adhesion material is polyethyleneimine (PEI) which can be used in one or more coating layers. These polymers have numerous available primary, secondary or tertiary amine groups, which are effective in increasing the adhesion of barrier layers. In some embodiments, PEI is a highly branched polymer with about 25% primary amine groups, 50% secondary amine groups, and 25% tertiary amine groups A PEI can promote adhesion, disperse fillers and pigments, and enhance wetting characteristics. In some embodiments, a PEI may additionally scavenge oxides of carbon, nitrogen, sulfur, volatile aldehydes, chlorine, bromine and organic halides. In some embodiments, PEIs may be present in an aqueous emulsion or dispersion. In some embodiments, the molecular weight of PEIs is from about 5,000-1,000,000. In some embodiments, the addition of polyethylene amine to a gas barrier coating layer or a water-resistant coating layer results in a decrease in the rate of transmission of CO₂ through the barrier layers and article substrate. In some embodiments, PEI comprises a copolymer of ethylene imine such as the copolymer of acrylamide and ethylene imine. In some embodiments, one or more PEI can be used in amount of less than about 10 wt % based on the total weight of the layer. In some embodiments, the PEI is about 10 to about 20 wt %. In other embodiments, the PEI is about 0.01 to about 5 wt %.

4. Other Functional Layers and Materials

As described above, one or more layers may also comprise materials to achieve other desired properties for the label. In some non-limiting embodiments, sheets or labels may comprise one or more layers or portions having one or more of the following advantageous characteristics: an insulating layer, a barrier layer, UV protection layers, protective layer (e.g., a vitamin protective layer, scuff resistance layer, etc.), a foodstuff contacting layer, a non-flavor scalping layer, non-color scalping layer. a high strength layer, a compliant layer, a tie layer, a gas scavenging layer (e.g., oxygen, carbon dioxide, etc), a layer or portion suitable for hot fill applications, a layer having a melt strength suitable for extrusion, strength, recyclable (post consumer and/or post-industrial), clarity, etc. In one embodiment, the monolayer or multi-layer material comprises one or more of the following materials: PET (including recycled and/or virgin PET), PETG, foam, polypropylene, phenoxy type thermoplastics, polyolefins, phenoxy-polyolefin thermoplastic blends, and/or combinations thereof.

### Gas Barrier Materials

Sheets or labels may comprise one or more gas barrier layers. In these embodiments, the gas barrier material comprises one or more materials which decrease the transmission of gases permeating the label, sheet, or the article substrate to which the label or sheet is applied. In some embodiments, the gas barrier layer comprises a material which results in the substantial decrease of gas permeation through the label or sheet. To this end, gas barrier materials may be deposited as layers on the label or sheet.

There are many materials which decrease the transmission of certain gases, including oxygen and carbon dioxide, through layers. As described herein, the material to be used in gas barrier layers is not particularly limited. In some embodiments, selection of materials may be based on the most compatible material in consideration of the article substrate material and the other coating layers materials. For example, some particular material may work in combination to substantially decrease the rate of gas transmission through the walls of the article substrate, while enhancing the adhesion between certain layers and/or the article substrate.

In one preferred embodiment, coating materials comprise thermoplastic materials. Vinyl alcohol polymers and copolymers have excellent resistance to permeation by gases, particularly to oxygen. Generally, a gas barrier layer comprising vinyl alcohol polymers or copolymers imparts advantages such as reduced permeability of oxygen, good resistance to oil, and stiffness to the label or sheet. Vinyl alcohol polymers and copolymers include polyvinyl alcohol (PVOH) and ethylene vinyl alcohol (EVOH) copolymer. Thus in some embodiments, a gas barrier layer may comprise one or more of PVOH and EVOH. In some embodiments, EVOH can be a hydrolyzed ethylene vinyl acetate (EVA) copolymer. In some embodiments, vinyl alcohol polymers or copolymers include EVA.

One preferred gas barrier material is EVOH copolymer. Layers prepared with EVOH differ in properties according to the ethylene content, saponification degree and molecular weight of EVOH. Examples of preferred EVOH materials include, but are not limited to, those having ethylene content of about 35 to about 90 wt %. In some embodiments, the ethylene content is about 50 to about 70 wt %. In other embodiments, the ethylene content is about 65 to about 80 wt %. In some embodiments, the ethylene content is about 25 to about 55 wt %. In some embodiments, it is preferred that the ethylene content is about 27 to about 40 wt %, based on the total weight of the ethylene and the vinyl alcohol. In some embodiments, lower ethylene content is preferred. In some embodiments, a lower ethylene content correlates with higher barrier potency of the gas barrier layer. In some embodiments, the saponification degree is about 20 to about 95%. In other embodiments, the saponification degree is about 70 to about 90%. However, the saponification degree can be less than or greater than the recited values depending on the application.

Generally, preferred vinyl alcohol polymer and copolymer materials form relatively stable aqueous based solutions, dispersions, or emulsions. In embodiments, the properties of the solutions/dispersions are not adversely affected by contact with water. Preferred materials range from about 10% solids to about 50% solids, including about 15%, 20%, 25%, 30%, 35%, 40% and 45%, and ranges encompassing such percentages, although values above and below these values are also contemplated. Preferably, the material used dissolves or disperses in polar solvents. These polar solvents include, but are not limited to, water, alcohols, and glycol ethers. Some dispersions comprises about 20 to about 50 mol % of EVOH copolymer. Other dispersions comprise from about 25 to about 45 mol % of EVOH copolymer.

In some embodiments, an ion-modified vinyl alcohol polymer or copolymer material can be used in the formation of a stabilized aqueous dispersions as described in U.S. Pat. No. 5,272,200 and U.S. Pat. No. 5,302,417 to Yamauchi et al. Other methods for producing aqueous EVOH copolymer compositions are described in U.S. Pat. Nos. 6,613,833 and 6,838,029 to Kawahara et al.

In some embodiments, commercially available EVOH solutions and dispersions may be used. For example, a suitable EVOH dispersion includes, but it not limited to, the EVAL™ product line as manufactured by Evalca of Kuraray Group.

Polyvinyl alcohol (PVOH) can also be used in gas barrier layers. PVOH is highly impermeable to gases, oxygen and carbon dioxide and aromas. In some embodiments, a gas barrier layer comprising PVOH is also water resistant. In some preferred embodiments, PVOH is partially hydrolyzed or fully hydrolyzed. Examples of PVOH material include, but is not limited to, the Dupont™ Elvanol® product line.

Preferably, the Phenoxy-Type Thermoplastics used in some embodiments comprise one of the following types:
(1) Hydroxy-Functional Poly(Amide Ethers) Having Repeating Units Represented by any One of the Formulae Ia, Ib or Ic: 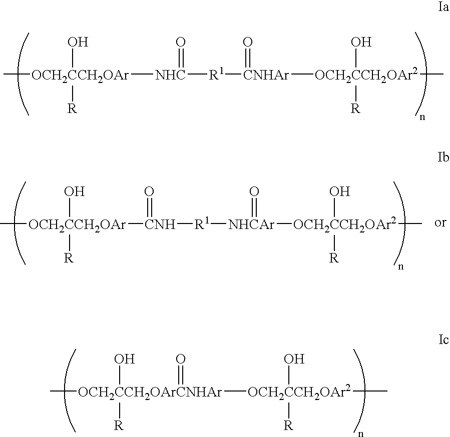
(2) Poly(Hydroxy Amide Ethers) Having Repeating Units Represented Independently by any One of the Formulae IIa, IIb or IIc: 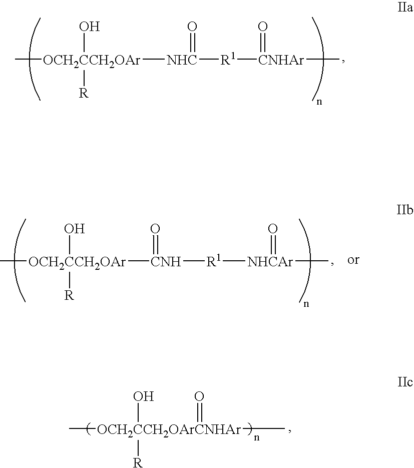
(3) Amide- and Hydroxymethyl-Functionalized Polyethers Having Repeating Units Represented by Formula III: 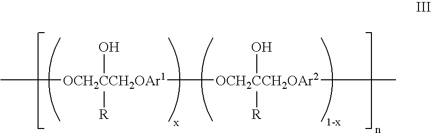
(4) Hydroxy-Functional Polyethers Having Repeating Units Represented by Formula IV: 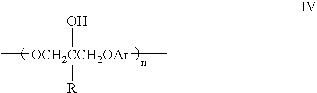
(5) Hydroxy-Functional Poly(Ether Sulfonamides) Having Repeating Units Represented by Formulae Va or Vb: 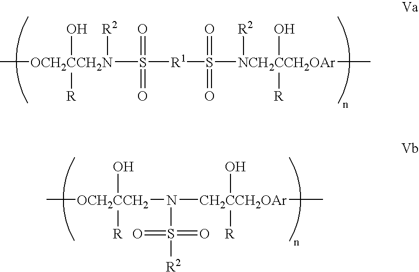
(6) Poly(Hydroxy Ester Ethers) Having Repeating Units Represented by Formula VI: 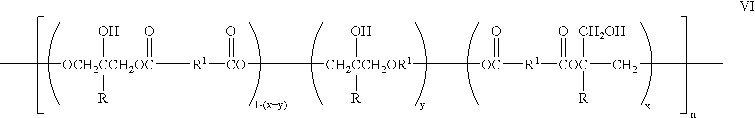
(7) Hydroxy-Phenoxyether Polymers Having Repeating Units Represented by Formula VII: 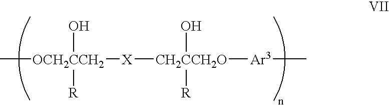
and
(8) Poly(Hydroxyamino Ethers) Having Repeating Units Represented by Formula VIII: 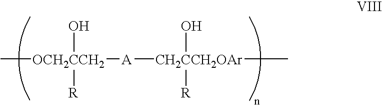
wherein each Ar individually represents a divalent aromatic moiety, substituted divalent aromatic moiety or heteroaromatic moiety, or a combination of different divalent aromatic moieties, substituted aromatic moieties or heteroaromatic moieties; R is individually hydrogen or a monovalent hydrocarbyl moiety; each Ar₁ is a divalent aromatic moiety or combination of divalent aromatic moieties bearing amide or hydroxymethyl groups; each Ar₂ is the same or different than Ar and is individually a divalent aromatic moiety, substituted aromatic moiety or heteroaromatic moiety or a combination of different divalent aromatic moieties, substituted aromatic moieties or heteroaromatic moieties; R₁ is individually a predominantly hydrocarbylene moiety, such as a divalent aromatic moiety, substituted divalent aromatic moiety, divalent heteroaromatic moiety, divalent alkylene moiety, divalent substituted alkylene moiety or divalent heteroalkylene moiety or a combination of such moieties; R₂ is individually a monovalent hydrocarbyl moiety; A is an amine moiety or a combination of different amine moieties; X is an amine, an arylenedioxy, an arylenedisulfonamido or an arylenedicarboxy moiety or combination of such moieties; and Ar₃ is a “cardo” moiety represented by any one of the Formulae:

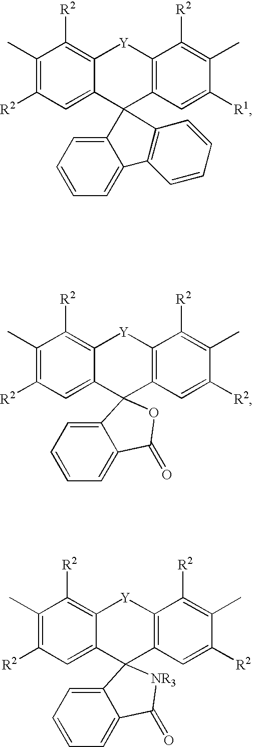

wherein Y is nil, a covalent bond, or a linking group, wherein suitable linking groups include, for example, an oxygen atom, a sulfur atom, a carbonyl atom, a sulfonyl group, or a methylene group or similar linkage; n is an integer from about 10 to about 1000; x is 0.01 to 1.0; and y is 0 to 0.5.

The term “predominantly hydrocarbylene” means a divalent radical that is predominantly hydrocarbon, but which optionally contains a small quantity of a heteroatomic moiety such as oxygen, sulfur, imino, sulfonyl, sulfoxyl, and the like.

The hydroxy-functional poly(amide ethers) represented by Formula I are preferably prepared by contacting an N,N′-bis(hydroxyphenylamido)alkane or arene with a diglycidyl ether as described in U.S. Pat. Nos. 5,089,588 and 5,143,998.

The poly(hydroxy amide ethers) represented by Formula II are prepared by contacting a bis(hydroxyphenylamido)alkane or arene, or a combination of 2 or more of these compounds, such as N,N′-bis(3-hydroxyphenyl)adipamide or N,N′-bis(3-hydroxyphenyl)glutaramide, with an epihalohydrin as described in U.S. Pat. No. 5,134,218.

The amide- and hydroxymethyl-functionalized polyethers represented by Formula III can be prepared, for example, by reacting the diglycidyl ethers, such as the diglycidyl ether of bisphenol A, with a dihydric phenol having pendant amido, N-substituted amido and/or hydroxyalkyl moieties, such as 2,2-bis(4-hydroxyphenyl)acetamide and 3,5-dihydroxybenzamide. These polyethers and their preparation are described in U.S. Pat. Nos. 5,115,075 and 5,218,075.

The hydroxy-functional polyethers represented by Formula IV can be prepared, for example, by allowing a diglycidyl ether or combination of diglycidyl ethers to react with a dihydric phenol or a combination of dihydric phenols using the process described in U.S. Pat. No. 5,164,472. Alternatively, the hydroxy-functional polyethers are obtained by allowing a dihydric phenol or combination of dihydric phenols to react with an epihalohydrin by the process described by Reinking, Barnabeo and Hale in the Journal of Applied Polymer Science, Vol. 7, p. 2135 (1963).

The hydroxy-functional poly(ether sulfonamides) represented by Formula V are prepared, for example, by polymerizing an N,N′-dialkyl or N,N′-diaryldisulfonamide with a diglycidyl ether as described in U.S. Pat. No. 5,149,768.

The poly(hydroxy ester ethers) represented by Formula VI are prepared by reacting diglycidyl ethers of aliphatic or aromatic diacids, such as diglycidyl terephthalate, or diglycidyl ethers of dihydric phenols with, aliphatic or aromatic diacids such as adipic acid or isophthalic acid. These polyesters are described in U.S. Pat. No. 5,171,820.

The hydroxy-phenoxyether polymers represented by Formula VII are prepared, for example, by contacting at least one dinucleophilic monomer with at least one diglycidyl ether of a cardo bisphenol, such as 9,9-bis(4-hydroxyphenyl)fluorene, phenolphthalein, or phenolphthalimidine or a substituted cardo bisphenol, such as a substituted bis(hydroxyphenyl)fluorene, a substituted phenolphthalein or a substituted phenolphthalimidine under conditions sufficient to cause the nucleophilic moieties of the dinucleophilic monomer to react with epoxy moieties to form a polymer backbone containing pendant hydroxy moieties and ether, imino, amino, sulfonamido or ester linkages. These hydroxy-phenoxyether polymers are described in U.S. Pat. No. 5,184,373.

The poly(hydroxyamino ethers) (“PHAE” or polyetheramines) represented by Formula VIII are prepared by contacting one or more of the diglycidyl ethers of a dihydric phenol with an amine having two amine hydrogens under conditions sufficient to cause the amine moieties to react with epoxy moieties to form a polymer backbone having amine linkages, ether linkages and pendant hydroxyl moieties. These compounds are described in U.S. Pat. No. 5,275,853. For example, polyhydroxyaminoether copolymers can be made from resorcinol diglycidyl ether, hydroquinone diglycidyl ether, bisphenol A diglycidyl ether, or mixtures thereof. The hydroxy-phenoxyether polymers are the condensation reaction products of a dihydric polynuclear phenol, such as bisphenol A, and an epihalohydrin and have the repeating units represented by Formula IV wherein Ar is an isopropylidene diphenylene moiety. The process for preparing these is described in U.S. Pat. No. 3,305,528, incorporated herein by reference in its entirety.

Generally, preferred phenoxy-type materials form relatively stable aqueous based solutions or dispersions. Preferably, the properties of the solutions/dispersions are not adversely affected by contact with water. Preferred materials range from about 10% solids to about 50% solids, including about 15%, 20%, 25%, 30%, 35%, 40% and 45%, and ranges encompassing such percentages, although values above and below these values are also contemplated. Preferably, the material used dissolves or disperses in polar solvents. These polar solvents include, but are not limited to, water, alcohols, and glycol ethers. See, for example, U.S. Pat. Nos. 6,455,116, 6,180,715, and 5,834,078 which describe some preferred phenoxy-type solutions and/or dispersions.

One preferred phenoxy-type material is a polyhydroxyaminoether (PHAE), dispersion or solution. The dispersion or solution, when applied to a container or preform, greatly reduces the permeation rate of a variety of gases through the container walls in a predictable and well known manner. One dispersion or latex made thereof comprises 10-30 percent solids. A PHAE solution/dispersion may be prepared by stirring or otherwise agitating the PHAE in a solution of water with an organic acid, preferably acetic or phosphoric acid, but also including lactic, malic, citric, or glycolic acid and/or mixtures thereof. These PHAE solution/dispersions also include organic acid salts as may be produced by the reaction of the polyhydroxyaminoethers with these acids.

In some embodiments, phenoxy-type thermoplastics are mixed or blended with other materials using methods known to those of skill in the art. In some embodiments a compatibilizer may be added to the blend. When compatibilizers are used, preferably one or more properties of the blends are improved, such properties including, but not limited to, color, haze, and adhesion between a layer comprising a blend and other layers. One preferred blend comprises one or more phenoxy-type thermoplastics and one or more polyolefins. A preferred polyolefin comprises polypropylene. In one embodiment polypropylene or other polyolefins may be grafted or modified with a polar molecule, group, or monomer, including, but not limited to, maleic anhydride, glycidyl methacrylate, acryl methacrylate and/or similar compounds to increase compatibility.

The following PHAE solutions or dispersions are examples of suitable phenoxy-type solutions or dispersions which may be used if one or more layers of resin are applied as a liquid such as by dip, flow, or spray coating, such as described in WO 04/004929 and U.S. Pat. No. 6,676,883.

Examples of polyhydroxyaminoethers are described in U.S. Pat. No. 5,275,853 to Silves et al. One suitable polyhydroxyaminoether is BLOX® experimental barrier resin, for example XU-19061.00 made with phosphoric acid manufactured by Dow Chemical Corporation. This particular PHAE dispersion is said to have the following typical characteristics: 30% percent solids, a specific gravity of 1.30, a pH of 4, a viscosity of 24 centipoise (Brookfield, 60 rpm, LVI, 22° C.), and a particle size of between 1,400 and 1,800 angstroms. Other suitable materials include BLOX® 588-29 resins based on resorcinol have also provided superior results as a barrier material. This particular dispersion is said to have the following typical characteristics: 30% percent solids, a specific gravity of 1.2, a pH of 4.0, a viscosity of 20 centipoise (Brookfield, 60 rpm, LVI, 22° C.), and a particle size of between 1500 and 2000 angstroms. Other suitable materials include BLOX® 5000 resin dispersion intermediate, BLOX® XUR 588-29, BLOX® 0000 and 4000 series resins. The solvents used to dissolve these materials include, but are not limited to, polar solvents such as alcohols, water, glycol ethers or blends thereof. Other suitable materials include, but are not limited to, BLOX® R1.

A preferred gas barrier layer comprises a blend of at least one polyhydroxyaminoether and a vinyl alcohol polymer or copolymer. In some embodiments, a PHAE may be blended with EVOH to provide a gas barrier layer for the label or sheet. In these embodiments, the EVOH/PHAE blends may be applied to the label or sheet by dip, spray, or flow coating an aqueous solution, dispersion or emulsion as described herein.

Blends of vinyl alcohol polymers or copolymers and Phenoxy-type Thermoplastics form stable aqueous solutions, dispersion, or emulsions. In some embodiments, a blend may comprises 5, 10, 15, 20, 25, 30, 35, 40, 45, 50, 55, 60, 65, 70, 75, 80, 85, 90, and about 95 wt % of at least one vinyl alcohol polymer or copolymer, based on the total weight of the vinyl alcohol polymer or copolymer and the Phenoxy-Type Thermoplastic. In preferred embodiments, the vinyl alcohol polymer or copolymer is EVOH or PVOH, as further described herein. In preferred embodiments, the Phenoxy-Type Thermoplastic is a PHAE.

Other variations of the polyhydroxyaminoether chemistry may prove useful such as crystalline versions based on hydroquinone diglycidylethers. Other suitable materials include polyhydroxyaminoether solutions/dispersions by Imperial Chemical Industries (“ICI,” Ohio, USA) available under the name OXYBLOK. In one embodiment, PHAE solutions or dispersions can be crosslinked partially (semi-cross linked), fully, or to the desired degree as appropriate for an application including by using a formulation that includes cross linking material. The benefits of cross linking include, but are not limited to, one or more of the following: improved chemical resistance, improved abrasion resistance, lower blushing, and lower surface tension. Examples of cross linker materials include, but are not limited to, formaldehyde, acetaldehyde or other members of the aldehyde family of materials. Suitable cross linkers can also enable changes to the T_{g} of the material, which can facilitate formation of certain containers. In one embodiment, preferred phenoxy-type thermoplastics are soluble in aqueous acid. A polymer solution/dispersion may be prepared by stirring or otherwise agitating the thermoplastic epoxy in a solution of water with an organic acid, preferably acetic or phosphoric acid, but also including lactic, malic, citric, or glycolic acid and/or mixtures thereof. In a preferred embodiment, the acid concentration in the polymer solution is preferably in the range of about 5%-20%, including about 5%-10% by weight based on total weight. In other preferred embodiments, the acid concentration may be below about 5% or above about 20%; and may vary depending on factors such as the type of polymer and its molecular weight. In other preferred embodiments, the acid concentration ranges from about 2.5 to about 5% by weight. The amount of dissolved polymer in a preferred embodiment ranges from about 0.1% to about 40%. A uniform and free flowing polymer solution is preferred. In one embodiment a 10% polymer solution is prepared by dissolving the polymer in a 10% acetic acid solution at 90° C. Then while still hot the solution is diluted with 20% distilled water to give an 8% polymer solution. At higher concentrations of polymer, the polymer solution tends to be more viscous. One preferred non-limiting hydroxy-phenoxyether polymer, PAPHEN 25068-38-6, is commercially available from Phenoxy Associates, Inc. Other preferred phenoxy resins are available from InChem® (Rock Hill, S.C.), these materials include, but are not limited to, the INCHEMREZ™ PKHH and PKHW product lines.

Other suitable materials include preferred copolyester materials as described in U.S. Pat. No. 4,578,295 to Jabarin. They are generally prepared by heating a mixture of at least one reactant selected from isophthalic acid, terephthalic acid and their C₁ to C₄ alkyl esters with 1,3 bis(2-hydroxyethoxy)benzene and ethylene glycol. Optionally, the mixture may further comprise one or more ester-forming dihydroxy hydrocarbon and/or bis(4-β-hydroxyethoxyphenyl)sulfone. Especially preferred copolyester materials are available from Mitsui Petrochemical Ind. Ltd. (Japan) as B-010, B-030 and others of this family.

Examples of preferred polyamide materials include MXD-6 from Mitsubishi Gas Chemical (Japan). Other preferred polyamide materials include Nylon 6, and Nylon 66. Other preferred polyamide materials are blends of polyamide and polyester, including those comprising about 1-20% polyester by weight, including about 1-10% polyester by weight, where the polyester is preferably PET or a modified PET, including PET ionomer. In another embodiment, preferred polyamide materials are blends of polyamide and polyester, including those comprising about 1-20% polyamide by weight, and 1-10% polyamide by weight, where the polyester is preferably PET or a modified PET, including PET ionomer. The blends may be ordinary blends or they may be compatibilized with one or more antioxidants or other materials. Examples of such materials include those described in U.S. Patent Publication No. 2004/0013833, filed Mar. 21, 2003, which is hereby incorporated by reference in its entirety. Other preferred polyesters include, but are not limited to, PEN and PET/PEN copolymers.

One suitable aqueous based polyester resin is described in U.S. Pat. No. 4,977,191 (Salsman), incorporated herein by reference. More specifically, U.S. Pat. No. 4,977,191 describes an aqueous based polyester resin, comprising a reaction product of 20-50% by weight of terephthalate polymer, 10-40% by weight of at least one glycol and 5-25% by weight of at least one oxyalkylated polyol.

Another suitable aqueous based polymer is a sulfonated aqueous based polyester resin composition as described in U.S. Pat. No. 5,281,630 (Salsman), herein incorporated by reference. Specifically, U.S. Pat. No. 5,281,630 describes an aqueous suspension of a sulfonated water-soluble or water dispersible polyester resin comprising a reaction product of 20-50% by weight terephthalate polymer, 10-40% by weight at least one glycol and 5-25% by weight of at least one oxyalkylated polyol to produce a prepolymer resin having hydroxyalkyl functionality where the prepolymer resin is further reacted with about 0.10 mole to about 0.50 mole of alpha, beta-ethylenically unsaturated dicarboxylic acid per 100 g of prepolymer resin and a thus produced resin, terminated by a residue of an alpha, beta-ethylenically unsaturated dicarboxylic acid, is reacted with about 0.5 mole to about 1.5 mole of a sulfite per mole of alpha, beta-ethylenically unsaturated dicarboxylic acid residue to produce a sulfonated-terminated resin.

Yet another suitable aqueous based polymer is described in U.S. Pat. No. 5,726,277 (Salsman), incorporated herein by reference. Specifically, U.S. Pat. No. 5,726,277 describes coating compositions comprising a reaction product of at least 50% by weight of waste terephthalate polymer and a mixture of glycols including an oxyalkylated polyol in the presence of a glycolysis catalyst wherein the reaction product is further reacted with a difunctional, organic acid and wherein the weight ratio of acid to glycols in is the range of 6:1 to 1:2.

While the above examples are provided as preferred aqueous based polymer coating compositions, other aqueous based polymers are suitable for use in the products and methods describe herein. By way of example only, and not meant to be limiting, further suitable aqueous based compositions are described in U.S. Pat. No. 4,104,222 (Date, et al.), incorporated herein by reference. U.S. Pat. No. 4,104,222 describes a dispersion of a linear polyester resin obtained by mixing a linear polyester resin with a higher alcohol/ethylene oxide addition type surface-active agent, melting the mixture and dispersing the resulting melt by pouring it into an aqueous solution of an alkali under stirring Specifically, this dispersion is obtained by mixing a linear polyester resin with a surface-active agent of the higher alcohol/ethylene oxide addition type, melting the mixture, and dispersing the resulting melt by pouring it into an aqueous solution of an alkanolamine under stirring at a temperature of 70-95° C., said alkanolamine being selected from the group consisting of monoethanolamine, diethanolamine, triethanolamine, monomethylethanolamine, monoethylethanolamine, diethylethanolamine, propanolamine, butanolamine, pentanolamine, N-phenylethanolamine, and an alkanolamine of glycerin, said alkanolamine being present in the aqueous solution in an amount of 0.2 to 5 weight percent, said surface-active agent of the higher alcohol/ethylene oxide addition type being an ethylene oxide addition product of a higher alcohol having an alkyl group of at least 8 carbon atoms, an alkyl-substituted phenol or a sorbitan monoacylate and wherein said surface-active agent has an HLB value of at least 12.

Likewise, by example, U.S. Pat. No. 4,528,321 (Allen) discloses a dispersion in a water immiscible liquid of water soluble or water swellable polymer particles and which has been made by reverse phase polymerization in the water immiscible liquid and which includes a non-ionic compound selected from C₄₋₁₂ alkylene glycol monoethers, their C₁₋₄ alkanoates, C₆₋₁₂ polyalkylene glycol monoethers and their C₁₋₄ alkanoates.

Additional gas barrier layers may additionally comprise one or more of ethylene vinyl acetate (EVA), linear low density polyethylene (LLDPE), polyethylene 2,6- and 1,5-naphthalate (PEN), polyethylene terephthalate glycol (PETG), poly(cyclohexylenedimethylene terephthalate), polylactic acid (PLA), polycarbonate, polyglycolic acid (PGA), polyhydroxyaminoethers, polyethylene imines, epoxy resins, urethanes, acrylates, polystyrene, cycloolefin, poly-4-methylpentene-1, poly(methyl methacrylate), acrylonitrile, polyvinyl chloride, polyvinylidine chloride (PVDC), styrene acrylonitrile, acrylonitrile-butadiene-styrene, polyacetal, polybutylene terephthalate, polymeric ionomers such as sulfonates of PET, polysulfone, polytetra-fluoroethylene, polytetramethylene 1,2-dioxybenzoate, polyurethane, and copolymers of ethylene terephthalate and ethylene isophthalate, and copolymers and/or blends of one or more of the foregoing.

In embodiments, the gas-barrier resistant coating may be applied as a water-soluble polymer solution, a water-based polymer dispersion, or an aqueous emulsion of the polymer.

### Water-Resistant Coating Materials

Certain materials are preferably applied as a layer that provides improved chemical resistance such as to hot water, steam, caustic or acidic materials, compared to one or more layers of the label or sheet. In certain embodiments, these layers are aqueous based or non-aqueous based polyesters, acrylics, acrylic acid copolymers such as EAA, polyolefins polymers or copolymers such as polypropylene or polyethylene, and blends thereof which are optionally partially or fully cross linked. One preferred aqueous based polyester is polyethylene terephthalate; however other polyesters may also be used.

Water-resistant layers are particularly useful in being applied to a label or sheet comprising a material or a layer of a material which degrades in the presence of water. Vinyl alcohol polymer or copolymers such as PVOH and EVOH tend to degrade when exposed to water. Thus, exposure to water degrades the performance of a gas barrier layer comprising vinyl alcohol polymer or copolymers, or other water sensitive gas barrier materials. In addition, some additives and other barrier materials such as UV protective barrier materials may also be sensitive to exposure to water.

In some embodiments, crosslinking between materials in an outer layer will substantially increase the water-resistant properties of inner layers and the article substrate. In some embodiments, the degree of crosslinking can be adjusted by cross linking density and degree.

In some embodiments, the label or sheet which may comprise an uncoated surface or a surface coated with one or more layers, can additionally be coated with a water-resistant coating material. In preferred embodiments, a material employed in a water-resistant coating layer is an acrylic polymer or copolymer. In some embodiments, the acrylic polymer or copolymer comprises one or more of a acrylic acid polymer or copolymer, a methacrylic acid polymer or copolymer, or the alkyl esters of methacrylic acid or acrylic acid polymers or copolymers. In some embodiments, the acrylic acid copolymer comprises ethylene acrylic acid (EAA) copolymer. EAA is produced by the high pressure copolymerization of ethylene and acrylic acid. In embodiments, EAA is a copolymer comprising from about 75 to about 95 wt % of ethylene and about 5 to about 25 wt % of acrylic acid. The copolymerization results in bulky carboxyl groups along the backbone and side chain of the copolymer. These carboxyl groups are free to form bonds and interact with polar substrates such as water. In addition, hydrogen bonds of the carboxyl groups may result in increased toughness of the barrier layer. EAA materials may also enhance the clarity, low melting point and softening point of the copolymer.

Salts of acrylic acid polymer or copolymers, such as an ammonium salt of EAA, permit the formation of aqueous dispersions of acrylic acid which allow ease of application in dip, spray, and flow coating processes as described herein. However, some embodiments of a composition comprising acrylate polymers or copolymers may also be applied as emulsions and solutions.

Commercially available examples of EAA aqueous dispersion include PRIMACOR available from DOW PLASTICS, as an aqueous dispersions having 25% solids content and obtained from the copolymerization of 80 wt % ethylene and 20 wt % acrylic acid. Michem® Prime 4983, Prime 4990R, Prime 4422R, and Prime 48525R, are available from Michelman as aqueous dispersions of EAA with solid content ranging from about 20% to about 40%. In some embodiments, EAA may be applied as a water-based or wax emulsion. In some embodiments, EAA dispersions or emulsions have low VOC content and are generally less than about 0.25 wt % of VOCs. However, some EAA dispersions or emulsions are substantially or completely free of VOCs.

In some embodiments, polyolefin polymers or copolymers may be used as a water-resistant coating material. For example, a label or sheet comprising a gas barrier layer comprising a vinyl alcohol polymer or copolymer can be further coated with a polyolefin polymer or copolymer such as polypropylene as a water-resistant coating layer. In some embodiments, blends of polyolefins and acrylic polymers and copolymers can be used as a water-resistant coating material. For example, polypropylene (PP) and EAA can be used as a water-resistant layer. Blends of EAA and PP may comprise about 5, 10, 15, 20, 25, 30, 35, 40, 45, 50, 55, 60, 65, 70, 76, 80, 85, 90, and 95 wt % of EAA, based on the total weight of the PP and EAA in the water-resistant coating layer.

One or more layers of polyolefin polymers or copolymers, such polyethylene or propylene, may be to a sheet or label comprising a vinyl alcohol polymer or copolymer, such as EVOH or PVOH, to reduce the water sensitivity and decrease water vapor transmission rate of the article substrate. In some embodiments, gas barrier layers comprising a vinyl alcohol polymer or copolymer, such as EVOH, and a Phenoxy-type thermoplastic, such as a PHAE, can be overcoated with layers of polyolefin polymer or copolymers such as polyethylene, polypropylene, or combinations thereof. In some embodiments, gas barrier layers comprising a vinyl alcohol polymer or copolymer, such as EVOH, and a Phenoxy-type thermoplastic, such as a PHAE, can be overcoated with a layer comprising EAA.

In other embodiments, the barrier layer comprising a vinyl alcohol polymer or copolymer, such as EVOH, may also comprise an additional additive which reduces the sensitivity of the vinyl alcohol polymer or copolymer to water, and/or increases the water resistance of the barrier layer. For example, a gas barrier layer comprising EVOH can be can substantially increase the water-resistance of the layer by adding a Phenoxy-type Thermoplastic, such as a PHAE. In some of these embodiments where EVOH is blended with polyhydroxyaminoethers, an additional top water-resistant coating layer may be used to further decrease the sensitivity of an underlying layer to water and to decrease the water transmission rate of the article substrate material. In any of the above examples, EVOH can be substituted with PVOH, or blends of EVOH/PVOH.

### Waxes

In some embodiments, a water-resistant layer comprises a wax. In some embodiments, the wax is a natural wax such as carnauba or paraffin. In other embodiments, the wax is a synthetic wax such polyethylene, polypropylene and Fischer-Tropsch waxes. Wax dispersions may be micronized waxes dispersed in water. Solvent dispersions are composed of wax combined with solvents. In some embodiments, the particle size of a wax dispersion typically is greater than one micron (1μ). However, the particle size of some dispersions may vary according to the desired coating layer and/or wax material.

In one preferred embodiment, a water-resistant coating layer comprises carnauba. Carnauba wax is a natural wax derived from the fronds of a Brazilian palm tree (Copemica cerifera). Because of its source, carnauba offers the benefit of being FDA-compliant. In addition, carnauba and carnauba-blend emulsions offer performance advantages where additional slip, mar resistance and block resistance are required.

Some carnaubas are available as high-solids emulsions and can be applied to article substrates as described herein. Some emulsions may comprise from about 10 to about 80 percent solids.

In other embodiments, a water-resistant coating layer comprises paraffins. In some embodiments, paraffins are low-molecular weight waxes with melt points ranging from 48° C. to 74° C. They may be highly refined, have low oil content and are straight-chain hydrocarbons. In preferred embodiments, a water-resistant coating layer comprising paraffins provide anti-blocking, slip, water resistance or moisture vapor transmission resistance. Some embodiments of water-resistant coating layers may comprise blends of carnauba and paraffins. In further embodiments, a water-resistant coating layer may comprises blends of polyolefins and waxes. Some embodiments of water-resistant coating materials may comprise blends of natural waxes and/or synthetic waxes. For example blends of carnauba wax and paraffins may be used in the water-resistant coating layers of some embodiments.

Water-based wax emulsions are commercially available from Michelson. In preferred embodiments, the waterborne wax emulsion has a low VOC content. Examples of a water-based carnauba wax emulsions with low VOC content is Michem Lube 156 and Michem Lube 160. Examples of a water-based blend of carnauba and paraffins with a low VOC content include Michem Lube 180 and Michem Lube 182. One example of a blended polyolefin/wax material for a water-resistant coating layer is Michem Lube 110 which contains polyethylene and paraffins.

5. Additives to Enhance Materials

Some embodiments of labels and sheets allow for the use of multiple functional additives. Additives known by those of ordinary skill in the art for their ability to provide enhanced CO₂ barriers, O₂ barriers, UV protection, scuff resistance, blush resistance, impact resistance and/or chemical resistance may be used.

Preferred additives may be prepared by methods known to those of skill in the art. For example, the additives may be mixed directly with a particular material, they may be dissolved/dispersed separately and then added to a particular material, or they may be combined with a particular material to addition of the solvent that forms the material solution/dispersion. In addition, in some embodiments, preferred additives may be used alone as a single layer.

In preferred embodiments, the barrier properties of a layer may be enhanced by the addition of different additives. Additives are preferably present in an amount up to about 40% of the material, also including up to about 30%, 20%, 10%, 5%, 2% and 1% by weight of the material. In other embodiments, additives are preferably present in an amount less than or equal to 1% by weight, preferred ranges of materials include, but are not limited to, about 0.01% to about 1%, about 0.01% to about 0.1%, and about 0.1% to about 1% by weight. Further, in some embodiments additives are preferably stable in aqueous conditions. For example, derivatives of resorcinol (m-dihydroxybenzene) may be used in conjunction with various preferred materials as blends or as additives or monomers in the formation of the material. The higher the resorcinol content the greater the barrier properties of the material. For example, resorcinol diglycidyl ether can be used in PHAE and hydroxyethyl ether resorcinol can be used in PET and other polyesters and Copolyester Barrier Materials.

Another additive that may be used are “nanoparticles” or “nanoparticulate material.” For convenience the term nanoparticles will be used herein to refer to both nanoparticles and nanoparticulate material. These nanoparticles are tiny, micron or sub-micron size (diameter), particles of materials which enhance the barrier properties of a material by creating a more tortuous path for migrating gas molecules, e.g. oxygen or carbon dioxide, to take as they permeate a material. In preferred embodiments nanoparticulate material is present in amounts ranging from 0.05 to 1% by weight, including 0.1%, 0.5% by weight and ranges encompassing these amounts.

One preferred type of nanoparticulate material is a microparticular clay based product available from Southern Clay Products. One preferred line of products available from Southern Clay products is Cloisite® nanoparticles. In one embodiment preferred nanoparticles comprise monmorillonite modified with a quaternary ammonium salt. In other embodiments nanoparticles comprise monmorillonite modified with a ternary ammonium salt. In other embodiments nanoparticles comprise natural monmorillonite. In further embodiments, nanoparticles comprise organoclays as described in U.S. Pat. No. 5,780,376, the entire disclosure of which is hereby incorporated by reference and forms part of the disclosure of this application. Other suitable organic and inorganic microparticular clay based products may also be used. Both man-made and natural products are also suitable.

Another type of preferred nanoparticulate material comprises a composite material of a metal. For example, one suitable composite is a water based dispersion of aluminum oxide in nanoparticulate form available from BYK Chemie (Germany). It is believed that this type of nanoparticular material may provide one or more of the following advantages: increased abrasion resistance, increased scratch resistance, increased T_{g}, and thermal stability.

Another type of preferred nanoparticulate material comprises a polymer-silicate composite. In preferred embodiments the silicate comprises montmorillonite. Suitable polymer-silicate nanoparticulate material are available from Nanocor and RTP Company.

In preferred embodiments, the UV protection properties of the material may be enhanced by the addition of different additives. In a preferred embodiment, the UV protection material used provides UV protection up to about 350 nm or less, preferably about 370 nm or less, more preferably about 400 nm or less. The UV protection material may be used as an additive with layers providing additional functionality or applied separately as a single layer. Preferably additives providing enhanced UV protection are present in the material from about 0.05 to 20% by weight, but also including about 0.1%, 0.5%, 1%, 2%, 3%, 5%, 10%, and 15% by weight, and ranges encompassing these amounts. Preferably the UV protection material is added in a form that is compatible with the other materials. For example, a preferred UV protection material is Milliken UV390A ClearShield®. UV390A is an oily liquid for which mixing is aided by first blending the liquid with water, preferably in roughly equal parts by volume. This blend is then added to the material solution, for example, BLOX® 599-29, and agitated. The resulting solution contains about 10% UV390A and provides UV protection up to 390 nm when applied to a PET preform. As previously described, in another embodiment the UV390A solution is applied as a single layer. In other embodiments, a preferred UV protection material comprises a polymer grafted or modified with a UV absorber that is added as a concentrate. Other preferred UV protection materials include, but are not limited to, benzotriazoles, phenothiazines, and azaphenothiazines. UV protection materials may be added during the melt phase process prior to use, e.g. prior to injection molding or extrusion, or added directly to a coating material that is in the form of a solution or dispersion. Suitable UV protection materials are available from Milliken, Ciba and Clariant.

In preferred embodiments, CO₂ scavenging properties can be added to the materials. In one preferred embodiment such properties are achieved by including an active amine which will react with CO₂ forming a high gas barrier salt. This salt will then act as a passive CO₂ barrier. The active amine may be an additive or it may be one or more moieties in the thermoplastic resin material of one or more layers.

In preferred embodiments, O₂ scavenging properties can be added to preferred materials by including O₂ scavengers such as anthroquinone and others known in the art. In another embodiment, one suitable O₂ scavenger is AMOSORB® O₂ scavenger available from BP Amoco Corporation and ColorMatrix Corporation which is disclosed in U.S. Pat. No. 6,083,585 to Cahill et al., the disclosure of which is hereby incorporated in its entirety. In one embodiment, O₂ scavenging properties are added to preferred phenoxy-type materials, or other materials, by including O₂ scavengers in the phenoxy-type material, with different activating mechanisms. Preferred O₂ scavengers can act either spontaneously, gradually or with delayed action until initiated by a specific trigger. In some embodiments the O₂ scavengers are activated via exposure to either UV or water (e.g., present in the contents of the container), or a combination of both. The O₂ scavenger is preferably present in an amount of from about 0.1 to about 20 percent by weight, more preferably in an amount of from about 0.5 to about 10 percent by weight, and, most preferably, in an amount of from about 1 to about 5 percent by weight, based on the total weight of the coating layer.

In another preferred embodiment, a top coat or layer is applied to provide chemical resistance to harsher chemicals than what is provided by the outer layer. In certain embodiments, preferably these top coats or layers are aqueous based or non-aqueous based polyesters or acrylics which are optionally partially or fully cross linked. A preferred aqueous based polyester is polyethylene terephthalate, however other polyesters may also be used. In certain embodiments, the process of applying the top coat or layer to the sheet or label is that disclosed in U.S. Patent Pub. No. 2004/0071885, entitled Dip, Spray, And Flow Coating Process For Forming Coated Articles, the entire disclosure of which is hereby incorporated by reference in its entirety. Other methods for applying layers of materials to the sheet or label are further disclosed herein.

A preferred aqueous based polyester resin is described in U.S. Pat. No. 4,977,191 (Salsman), incorporated herein by reference. More specifically, U.S. Pat. No. 4,977,191 describes an aqueous based polyester resin, comprising a reaction product of 20-50% by weight of waste terephthalate polymer, 10-40% by weight of at least one glycol an 5-25% by weight of at least one oxyalkylated polyol.

Another preferred aqueous based polymer is a sulfonated aqueous based polyester resin composition as described in U.S. Pat. No. 5,281,630 (Salsman), herein incorporated by reference. Specifically, U.S. Pat. No. 5,281,630 describes an aqueous suspension of a sulfonated water-soluble or water dispersible polyester resin comprising a reaction product of 20-50% by weight terephthalate polymer, 10-40% by weight at least one glycol and 5-25% by weight of at least one oxyalkylated polyol to produce a prepolymer resin having hydroxyalkyl functionality where the prepolymer resin is further reacted with about 0.10 mole to about 0.50 mole of alpha, beta-ethylenically unsaturated dicarboxylic acid per 100 g of prepolymer resin and a thus produced resin, terminated by a residue of an alpha, beta-ethylenically unsaturated dicarboxylic acid, is reacted with about 0.5 mole to about 1.5 mole of a sulfite per mole of alpha, beta-ethylenically unsaturated dicarboxylic acid residue to produce a sulfonated-terminated resin.

Yet another preferred aqueous based polymer is the coating described in U.S. Pat. No. 5,726,277 (Salsman), incorporated herein by reference. Specifically, U.S. Pat. No. 5,726,277 describes coating compositions comprising a reaction product of at least 50% by weight of waste terephthalate polymer and a mixture of glycols including an oxyalkylated polyol in the presence of a glycolysis catalyst wherein the reaction product is further reacted with a difunctional, organic acid and wherein the weight ratio of acid to glycols in is the range of 6:1 to 1:2.

While the above examples are provided as preferred aqueous based polymer coating compositions, other aqueous based polymers are suitable for use in the products and methods describe herein. By way of example only, and not meant to be limiting, further suitable aqueous based compositions are described in U.S. Pat. No. 4,104,222 (Date et al.), incorporated herein by reference. U.S. Pat. No. 4,104,222 describes a dispersion of a linear polyester resin obtained by mixing a linear polyester resin with a higher alcohol/ethylene oxide addition type surface-active agent, melting the mixture and dispersing the resulting melt by pouring it into an aqueous solution of an alkali under stirring Specifically, this dispersion is obtained by mixing a linear polyester resin with a surface-active agent of the higher alcohol/ethylene oxide addition type, melting the mixture, and dispersing the resulting melt by pouring it into an aqueous solution of an alkanolamine under stirring at a temperature of 70-95° C., said alkanolamine being selected from the group consisting of monoethanolamine, diethanolamine, triethanolamine, monomethylethanolamine, monoethylethanolamine, diethylethanolamine, propanolamine, butanolamine, pentanolamine, N-phenylethanolamine, and an alkanolamine of glycerin, said alkanolamine being present in the aqueous solution in an amount of 0.2 to 5 weight percent, said surface-active agent of the higher alcohol/ethylene oxide addition type being an ethylene oxide addition product of a higher alcohol having an alkyl group of at least 8 carbon atoms, an alkyl-substituted phenol or a sorbitan monoacylate and wherein said surface-active agent has an HLB value of at least 12.

Likewise, by example, U.S. Pat. No. 4,528,321 (Allen) discloses a dispersion in a water immiscible liquid of water soluble or water swellable polymer particles and which has been made by reverse phase polymerization in the water immiscible liquid and which includes a non-ionic compound selected from C₄₋₁₂ alkylene glycol monoethers, their C₁₋₄ alkanoates, C₆₋₁₂ polyalkylene glycol monoethers and their C₁₋₄ alkanoates.

The materials of certain embodiments may be cross-linked to enhance thermal stability for various applications, for example hot fill applications. In one embodiment, inner layers may comprise low-cross linking materials while outer layers may comprise high crosslinking materials or other suitable combinations. For example, an inner coating on a PET surface may utilize non or low cross-linked material, such as the BLOX® 588-29, and the outer coat may utilize another material, such as EXP 12468-4B from ICI, capable of cross linking to ensure maximum adhesion to the PET. Suitable additives capable of cross linking may be added to one or more layers. Suitable cross linkers can be chosen depending upon the chemistry and functionality of the resin or material to which they are added. For example, amine cross linkers may be useful for crosslinking resins comprising epoxide groups. Preferably cross linking additives, if present, are present in an amount of about 1% to 10% by weight of the coating solution/dispersion, preferably about 1% to 5%, more preferably about 0.01% to 0.1% by weight, also including 2%, 3%, 4%, 6%, 7%, 8%, and 9% by weight. Optionally, a thermoplastic epoxy (TPE) can be used with one or more crosslinking agents. In some embodiments, agents (e.g. carbon black) may also be coated onto or incorporated into the TPE material. The TPE material can form part of the articles disclosed herein. It is contemplated that carbon black or similar additives can be employed in other polymers to enhance material properties.

The materials of certain embodiments may optionally comprise a curing enhancer. As used herein, the term “curing enhancer” is a broad term and is used in its ordinary meaning and includes, without limitation, chemical cross-linking catalyst, thermal enhancer, and the like. As used herein, the term “thermal enhancer” is a broad term and is used in its ordinary meaning and includes, without limitation, transition metals, transition metal compounds, radiation absorbing additives (e.g., carbon black). Suitable transition metals include, but are not limited to, cobalt, rhodium, and copper. Suitable transition metal compounds include, but are not limited to, metal carboxylates. Preferred carboxylates include, but are not limited to, neodecanoate, octoate, and acetate. Thermal enhancers may be used alone or in combination with one or more other thermal enhancers.

The thermal enhancer can be added to a material and may significantly increase the temperature of the material during a curing process, as compared to the material without the thermal enhancer. For example, in some embodiments, the thermal enhancer (e.g., carbon black) can be added to a polymer so that the temperature of the polymer subjected to a curing process (e.g., IR radiation) is significantly greater than the polymer without the thermal enhancer subject to the same or similar curing process. The increased temperature of the polymer caused by the thermal enhancer can increase the rate of curing and therefore increase production rates. In some embodiments, the thermal enhancer generally has a higher temperature than at least one of the layers of an article when the thermal enhancer and the article are heated with a heating device (e.g., infrared heating device).

In some embodiments, the thermal enhancer is present in an amount of about 5 to 800 ppm, preferably about 20 to about 150 ppm, preferably about 50 to 125 ppm, preferably about 75 to 100 ppm, also including about 10, 20, 30, 40, 50, 75, 100, 125, 150, 175, 200, 300, 400, 500, 600, and 700 ppm and ranges encompassing these amounts. The amount of thermal enhancer may be calculated based on the weight of layer which comprises the thermal enhancer or the total weight of all layers comprising the article.

In some embodiments, a preferred thermal enhancer comprises carbon black. In one embodiment, carbon black can be applied as a component of a coating material in order to enhance the curing of the coating material. When used as a component of a coating material, carbon black is added to one or more of the coating materials before, during, and/or after the coating material is applied (e.g., impregnated, coated, etc.) to the article. Preferably carbon black is added to the coating material and agitated to ensure thorough mixing. The thermal enhancer may comprise additional materials to achieve the desire material properties of the article.

In another embodiment wherein carbon black is used in an injection molding process, the carbon black may be added to the polymer blend in the melt phase process.

In some embodiments, the polymer comprises about 5 to 800 ppm, preferably about 20 to about 150 ppm, preferably about 50 to 125 ppm, preferably about 75 to 100 ppm, also including about 10, 20, 30, 40, 50, 75, 100, 125, 150, 175, 200, 300, 400, 500, 600, and 700 ppm thermal enhancer and ranges encompassing these amounts. In a further embodiment, the coating material is cured using radiation, such as infrared (IR) heating. In preferred embodiments, the IR heating provides a more effective coating than curing using other methods. Other thermal and curing enhancers and methods of using same are disclosed in U.S. patent application Ser. No. 10/983,150, filed Nov. 5, 2004, entitled “Catalyzed Process for Forming Coated Articles,” the disclosure of which is hereby incorporated by reference it its entirety.

In some embodiments the addition of anti-foam/bubble agents is desirable, In some embodiments utilizing solutions or dispersion the solutions or dispersions form foam and/or bubbles which can interfere with preferred processes. One way to avoid this interference, is to add anti-foam/bubble agents to the solution/dispersion. Suitable anti-foam agents include, but are not limited to, nonionic surfactants, alkylene oxide based materials, siloxane based materials, and ionic surfactants. Preferably anti-foam agents, if present, are present in an amount of about 0.01% to about 0.3% of the solution/dispersion, preferably about 0.01% to about 0.2%, but also including about 0.02%, 0.03%, 0.04%, 0.05%, 0.06%, 0.07%, 0.08%, 0.09%, 0.1%, 0.25%, and ranges encompassing these amounts.

In another embodiment foaming agents may be added to the coating materials in order to foam the coating layer. In a further embodiment a reaction product of a foaming agent is used. Useful foaming agents include, but are not limited to azobisformamide, azobisisobutyronitrile, diazoaminobenzene, N,N-dimethyl-N,N-dinitroso terephthalamide, N,N-dinitrosopentamethylene-tetramine, benzenesulfonyl-hydrazide, benzene-1,3-disulfonyl hydrazide, diphenylsulfon-3-3, disulfonyl hydrazide, 4,4′-oxybis benzene sulfonyl hydrazide, p-toluene sulfonyl semicarbizide, barium azodicarboxylate, butylamine nitrile, nitroureas, trihydrazino triazine, phenyl-methyl-urethane, p-sulfonhydrazide, peroxides, ammonium bicarbonate, and sodium bicarbonate. As presently contemplated, commercially available foaming agents include, but are not limited to, EXPANCEL®, CELOGEN®, HYDROCEROL®, MIKROFINE®, CEL-SPAN®, and PLASTRON® FOAM.

The foaming agent is preferably present in the coating material in an amount from about 1 up to about 20 percent by weight, more preferably from about 1 to about 10 percent by weight, and, most preferably, from about 1 to about 5 percent by weight, based on the weight of the coating layer. Newer foaming technologies known to those of skill in the art using compressed gas could also be used as an alternate means to generate foam in place of conventional blowing agents listed above.

The tie-layer is preferably a polymer having functional groups, such as anhydrides and epoxies that react with the carboxyl and/or hydroxyl groups on the PET polymer chains. Useful tie-layer materials include, but are not limited to, DuPont BYNEL®, Mitsui ADMER®, Eastman's EPOLINE, Arkema's LOTADER and ExxonMobil's EVELOY®.

In some preferred embodiments labels or sheet comprising polypropylene, and methods of making the same, are disclosed. In one embodiment polypropylene may be grafted or modified with maleic anhydride, glycidyl methacrylate, acryl methacrylate and/or similar compounds to improve adhesion. In another embodiment polypropylene further comprises “nanoparticles” or “nanoparticular material.” In another embodiment polypropylene comprises nanoparticles and is grafted or modified with maleic anhydride, glycidyl methacrylate, acryl methacrylate and/or similar compounds.

6. Preferred Configurations

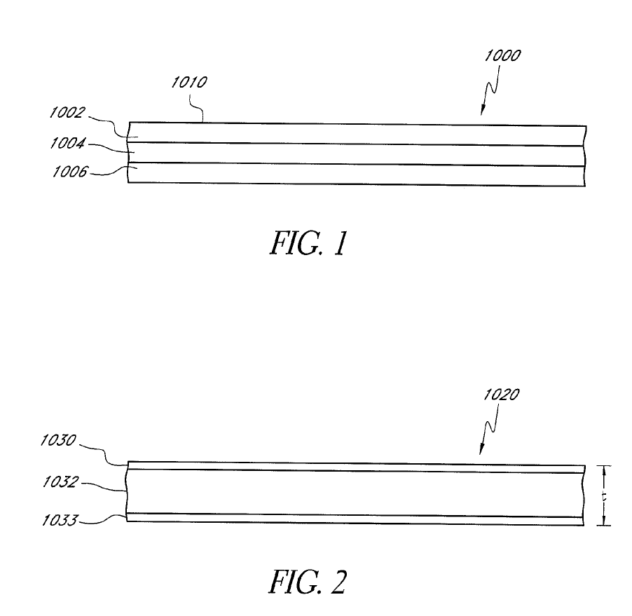

One configuration of the sheet or label is described in FIG. 1. FIG. 1 illustrates a multi-layer laminate in the form of a sheet 1000 that comprises a foam or expandable material. The foam or expandable material can provide a thermal barrier to reduce heat transfer through the sheet 1000. As such, the sheet 1000 can be used as an insulator for packaging.

The sheet or label 1000 includes a first layer 1002, a second layer 1004, and a third layer 1006. In the illustrated embodiment, the first layer 1002 and the third layer 1006 are outer layers of the sheet; however, other configurations are possible. In some embodiments, the first layer 1002 can form an outer surface 1010 that may or may not be suitable for receiving indicia. In some embodiments, the first layer 1002 is designed to receive printing directly printed thereon. For example, the first layer 1002 can have a relatively smooth surface 1010 that is suitable for receiving ink, embossing, and other indicium or indicia. The surface 1010 can be treated with a material to further enhance its printability or aesthetic functions. In one embodiment, the surface 1010 is a thin film. In another embodiment, the surface 1010 is coated with thin paper, plastic, or other materials disclosed herein. In some embodiments, the material used to coat the surface is a material suitable to receive indicia. In some embodiments, the material is suitable to receive print prior to, during, or after coating on the first layer 1002.

The first layer 1002 can be printed upon before, during, or after the sheet 1000 is applied to a container. It is contemplated that the sheet 1000 can have any number of layers. For example, the sheet 1000 can comprise a plurality of intermediate layers between the first layer 1002 and the third layer 106. Additionally, the thicknesses of each of the layers can be selected to achieve the desired properties. For example, to increase the thermal barrier properties of the sheet 1000, the foamed layer 1004 can have a relatively high thickness as compared to the non-foam layers. In one embodiment, the outer surface 1010 may be coated by an additional functional material as described herein. In some embodiments, this coated may provide moisture resistance, scuff and wear resistance, a glossy finish, a gas barrier, any other desired property, or combinations of any other foregoing.

In some embodiments, the second layer 1004 can be a thermal insulating layer configured to minimize heat transfer through the sheet 1000. The thermal conductivity of the second layer 1004 can be equal to or less than the thermal conductivity of at least one of the first layer 1002, the third layer 1006, or article substrate that the sheet 1000 is applied to. The second layer 1004 can be formed of foamed or expandable material as further described herein. Additionally, the second layer 1004 can be formed of paper. The foam material, expandable material, or paper can comprise microspheres or other suitable structures for forming a thermal barrier. For example, the second layer 1004 can be open or closed cell foam that may or may not comprise microspheres. In some embodiments, the foam is a polypropylene foam. In another embodiment, the second layer can comprise wood pulp which comprises microspheres. Additionally, the second layer 1004 can comprise a plurality of discrete layers, each containing a different or the same functional material.

In certain embodiments, the sheet or label may be affixed to the article through any means. In some embodiments, the third layer 1006 can be configured to contact an article. In some embodiments, the third layer 1006 may also form a layer suitable for adhering to a container. The adhesive properties of the third layer 1006 can be achieved by using a material with desirable adhesive properties. One or more additives can be used to form the third layer 1004 to achieve appropriate adhesive properties. For example, an adhesive additive can be added to a polymer to form a material with adhesive properties. In some embodiments, the third layer 106 comprises a thermoplastic polymer that is suitable for forming an adhesive layer. In one particular embodiment, the thermoplastic polymer is polypropylene. In this embodiment, the polypropylene can form a thermal barrier that further reduces heat transfer through the sheet 1000. Alternatively, other materials, such as a polyester (e.g. PET), can be used to form the third layer 106. As such, the sheet 1000 can be a self-adhesive label. Additionally, in some embodiments, an adhesive is not required to be a continuous layer. For example, adhesive may only partially cover the second layer 1006.

It is contemplated that the sheet 1000 can have any number of layers. For example, the sheet 1000 can comprise a plurality of intermediate layers between the first layer 1002 and the third layer 106. Additionally, the thicknesses of each of the layers can be selected to achieve the desired properties. For example, to increase the thermal barrier properties of the sheet 1000, the expandable layer 1004 can have a relatively high thickness as compared to the one or more other layers.

Another nonlimiting embodiment is shown in FIG. 2. In this embodiment, a sheet 1020 comprises a first layer 1030, a second layer 1032, and a third layer 1033. The first layer 1030 and the third layer 1033 form outermost surfaces of the sheet 1020. The second layer 1032 forms an intermediate layer between the upper layer 1030 and the lower layer 1033. In some embodiments, the second layer 1032 is an insulating layer and can be relatively thick as compared to the other layers 1030, 1033. In the illustrated embodiment, the second layer 1032 is substantially thicker than at least one of the first layer 1030 and the third layer 1033. For example, the intermediate layer 1032 can form at least 50% of the thickness, t, of the sheet 1020. In some embodiments, the intermediate layer 1032 can form at least 60%, 80%, 90%, 95%, 98%, 99% of the overall thickness t of the sheet 1020. The intermediate layer 1032 can therefore form an effective thermal barrier for reducing heat transfer through the sheet 1020. Accordingly, the sheet 1020 has a reduced thickness t while also providing desirable thermal characteristics.

The optional upper and lower layers of the sheets can be formed of any suitable material. For example, the upper and lower layers may be formed of a thermoplastic material. In some embodiments, the thermoplastic material can comprise polypropylene, which has relatively good insulating properties. For example, the sheet 1000 of FIG. 1 can have a first layer 1002 and a third layer 106 that comprise mostly polypropylene. The second layer 1004 can comprise polypropylene and/or microspheres. Alternatively, the second layer 1004 can comprise paper and/or microspheres.

In embodiments where the sheet 1000 may be formed by extrusion, unblown microspheres in the second layer 1004 can be heated such that when the sheet 1000 passes out of the die of the extruder, the microspheres will expand. That is, the microspheres of the sheet 1000 are blown as they pass out of the die. Alternatively, the second layer 1004 can comprise a mixture of fully blown (e.g., expanded microspheres), partially blown, and unblown microspheres (e.g., collapsed microspheres). As the sheet is passed out of the die of the extruder, the unblown, partially blown, or fully blown microspheres can be further expanded. The combination of the unblown, partially blown, and fully blown microspheres can maximize the number of voids in the second layer 1004. Of course, some of the microspheres may remain completely unblown; however, the unblown (e.g., unexpanded microspheres) create less voids and thus may reduce its insulating properties.

Sheets can be formed by blowing process using a standard chemical or physical blowing agent. For example, the sheet can be extruded wherein the second layer 1004 comprises a chemical or physical blowing agent and may or may not include microspheres. As the sheet 1000 is extruded out of the extruder, the second layer 1004 can form foamed material. In some embodiments, foam material with somewhat lower densities can be achieved by using compressed gas, such as butane, dichloroethane, or other suitable densities. For example, compressed gas can be used to form foamed material having a density of about 0.03 g/cc of closed cellular foam. In some embodiments, foamed material can be formed by a combination of gas and foamed material comprising microspheres, such as Expancel. In some embodiments, a foamed material can be formed by utilizing microspheres and blowing agent (e.g., chemical blowing agents, physical blowing agents, etc.). Various types of materials (e.g., gas including compressed gas, microspheres, blowing agents, combinations thereof) can be used to form at least a portion of the sheet 1000.

The sheets disclosed herein can have any thickness suitable for being applied to packaging. In some embodiments, the sheets have thicknesses of about 20 mil, 30 mil, 40 mil, 50 mil, 60 mil, and ranges encompassing such thicknesses. In some non-limiting embodiments, the sheets have a thickness of about 40 mil and comprise open cell foam. In some embodiments, the sheets have a thin layer of about 0.5 mil, 1 mil, 2 mil and ranges encompassing such thicknesses. For example, the layer 1030 of FIG. 2 can have a thickness of about 1 mil and can form a printed label (e.g., a mono or a multilayer label). In some embodiments, the sheets may also be converted into label stock.

In some embodiments, the sheet or labels comprises a layer that could be directly printable. Additionally, the sheet may be printable. In another embodiments, the sheet or label comprises a layer that has already received print prior to, during, or after the formation of the sheet or label. Thus, a single monolayer sheet can provide both insulating properties and a printable surface. The sheet can also provide a desirable tactile feel.

In one preferred embodiment, a label comprises foam which provides enhanced insulating and/or visual and tactile properties. In some embodiments, a label may be coated with a solution or dispersion of one or more polyolefins. In some embodiments, the label is coated with a solution or dispersion of polypropylene. In some embodiments, polypropylene is a carrier of microspheres. In some of these embodiments, a thin layer of polypropylene and microspheres may be coated as one or more layers of the label. In one particular embodiment, the coating layer is less than 40 mils. In another embodiment, the coating layer is less than 30 mils. In another embodiment, the coating layer is less than 20 mils. In another embodiment, the coating layer is less than 10 mils. In some of these embodiments, the total thickness of the label is less than 10 miles, including from about 3 to about 8 mils. Such labels may then be exposed to heat, as further described herein, to causing foaming of the layers.

In some embodiments, a foam label can be formed from an extruded foam sheet. In one embodiment, a foam label can comprise a light-weight closed cell foam base with a density less than about 0.1 g/cc, and preferably between about 0.05 g/cc and about 0.01 g/cc. This material preferably is suitable for receiving graphics and preferably has suitable tear strength. For example, in some embodiments, suitable tear strength and graphics receiving properties can be obtained by using a reverse printed OPP (Orientated Polypropylene) label with an adhesive backing. In other embodiments, suitable printable materials may be used.

In some embodiments, the label or sheet has a thickness of less than about 10 mils, including about 1, 2, 3, 4, 5, 6, 7, 8, 9, 10 and any values between the foregoing. Such label stock can easily accommodate more labels per roll as compared to thicker labels and label stock having a thickness of greater than 10 mils. For example, certain foamed label stock has a thickness of about 40 miles. As many foamed labels are thicker than standard paper labels, fewer foamed labels fit on the standard label rolls as compared to standard paper labels. Additional labor may be required to change the rolls more quickly in a production line setting. Changing label rolls more often may result in additional label costs and decreased production line efficiency. Thus, one embodiment of a sheet or label comprises paper or pulp, wherein the label is has a thickness of less than about 10 mils. In another embodiment of a sheet or label is a standard paper label.

In the foregoing embodiments, sheets or labels comprising paper or pulp may also be coated or laminated with microspheres. In one embodiment, a sheet or label comprises paper in a first layer and microspheres in a second layer. In another embodiment, a sheet or label comprises paper and microspheres in the same layer. In another embodiment, a sheet or label comprises paper in a first layer and microspheres in one or more layers. In some embodiments, paper and microspheres may comprise one or more additional, functional layers.

Additionally, in some embodiments, sheets or labels comprise paper and an expandable material. In some embodiments, the expandable material comprises microspheres and a carrier material. For example, in some embodiments, a layer of microspheres and one or more thermoplastic materials may be coated on the surface of the paper label. The thermoplastic material which is used together with the microspheres may also be selected based on the particular application. One desirable gas barrier material is a PHAE. Additional suitable gas barrier materials are further described herein. In some embodiments, the microspheres can be used together with an insulating material. In some embodiments, a preferred insulating material is a foamed closed cell material. However, some open cell materials may also provide additional desired insulating or other properties. In some embodiments, a moisture barrier material can be used together with the microspheres. Preferred moisture barrier materials includes EVOH, EVA, PVOH, PVA and the like, and are further described herein.

Carrier materials for such embodiments are further described herein. One preferred carrier material that can be used together with microsphere coatings is an organic carrier. Preferred organic carriers include ethylene ethyl acrylate, polypropylene, polyethylene, combination of the foregoing, copolymers of the foregoing, and any combination thereof. Another preferred carrier material comprises acrylic or styrene butadiene latex. In some embodiments, the carriers may include binders, polymers, or other materials used in a paper forming process. In some embodiments, these materials may enhance certain properties of the label or sheet. Certain properties may be enhanced through the use of polymers. In some embodiments, polymeric carriers may enhance the adhesion of the label, sheet, or laminate (some of these include paper))

One advantage of including microspheres with a paper label is the improvement of certain physical and mechanical properties of the label. For example, the inclusion of an additional layer of an expandable material comprising microspheres and a carrier, is the improvement of the wear resistance of such label. Additional advantages are further disclosed herein. Another advantage of sheets or labels comprising paper include the ability of the paper to be reprocessed or recycled. In one embodiment, a label may be exposed to heat and moisture which penetrate one or more top layers exposing the foam and/or paper. In some embodiments, mechanical means will allow for repulping the paper substrate of the label or sheet.

According to additional embodiments, a sheet or label can be formed as a shrinkable sheet or label. In some embodiments, the sheet or label comprises an elastomeric shrinkable material. In some embodiments, the shrinkable material is heat activated. Shrinkage of the label preferably does not significantly affect the label's insulative properties. In one embodiment, a shrinkable film label can be laminated with reverse printed graphics on a treated foam surface. The shrinkable film label preferably comprises one or more of PVC, PETG, OPS (Oriented PS), and K-resin in some embodiments. Similarly, OPP can also be used in some embodiments to produce between about 1% and about 30% shrinkage, and preferably between about 5% and about 22% shrinkage, in the machine direction. In some other embodiments, both the foam and the laminated graphics label layer can be shrinkable. For example, in one embodiment, the foam substrate can be elastomeric. In another embodiment, the foam substrate can be heat activated to shrink with heat. Some shrinkage in PP foam, for example, can be achievable in the machine direction and can be triggered by heating. In another embodiment, a foam cylinder or sleeve can be extruded to fit loosely over the label panel of a container or bottle. The foam sleeve can be caused to shrink with heat in the machine direction.

B. Method and Apparatuses for Forming and Applying Sheets, Labels, and Label Stock Comprising Foam Material

The multi-layer sheets described herein may be formed in a single extrusion process. However, the sheets can also be formed by a multi-step process. For example, the sheet 1000 of FIG. 1 can be formed in a multi-step extrusion process. One or more of the layers of the sheet 1000 can be formed by a first extruder and one or more of the sheets can be formed by a second extruder. The sheets can then be combined to form the sheet 1000.

Alternatively, one or more layers of the sheets or labels may be made by any suitable method, including, but not limited to (1) dip coating, (2) spray coating, (3) flow coating; (4) roller coating; (5) flame spraying, (6) fluidized bed dipping, (7) electrostatic powder spray, (8) overmolding (e.g., inject over inject) and/or (9) injection molded (including co-injection). Additionally, sheets or labels may be made by methods and apparatuses disclosed in the references incorporated by reference into the present application.

In some embodiments involving extrusion of a sheet, as soon as the foam emerges from the die head an extrusion coating with a polymer such as polyethylene or polypropylene is rapidly applied. In some embodiments, this has the benefit of providing increased tear resistance, improved surface gloss (better printability), and enhanced integrity and stability of the foam. In some embodiments, an extruded PE or PP coating can be applied as a co-layer in the extrusion die head so that it forms a laminated composite as it exits the die head. In addition, in some embodiments, a second layer can also be extruded and laminated on to the extruded foam down stream from the first extrusion process.

Additionally, in some embodiments, microspheres can be used as nuclear agents in the foam to reduce the density still further (opening up and creating more closed cells). The microspheres can serve to produce the foam by themselves or as nucleating agents and work synergistically with blowing agents and/or with gas injection. Microspheres can be introduced as unexpanded spheres that expand when heated by molten polymer or as pre-expanded spheres. The gases injected preferably are one or more of butane, pentane, octane, carbon dioxide, nitrogen and fluoroethanes such as DuPont's C152. In some embodiments, this can result in bimodal distribution of spheres that produces a tighter packing density than a unimodal narrow distribution of expanded spheres.

In another preferred embodiment, a sheet or label may be coated with an aqueous solution or dispersion comprising microspheres and an optional carrier material. The sheet or label may comprise paper. In some embodiments, labels comprising paper may be coated with one or more coating layers. One or more coating layers may comprise microspheres. In preferred embodiments, microspheres may be suspended in an aqueous dispersion or solution applied to the sheet or label through the foregoing methods. As mentioned above, an aqueous solution or dispersion comprising the microspheres may also comprise a carrier material which may be applied to the sheet or label. In some embodiments, the carrier material provides a medium in which the microspheres may be dispersed.

In another embodiment, a composition comprising cellulose fibers (e.g., pulp) may be mixed with microspheres and optionally a carrier material prior to forming the sheet or label. The density of such cellulose fiber may then be controlled to allow more absorption of the microspheres. Methods of adjusting the density of cellulose fibers of paper are well known in the art. One method of adjusting the density of cellulose material comprise adding chemical modifiers to the mixture comprising the cellulose material. A sheet or label produced through this method may allow for high volumes of microspheres to be incorporated into the paper comprising layer of the sheet or label. In one embodiment, a method of making a label comprises mixing cellulose fibers with microspheres to form a mixture and forming a paper label from the mixture. In some embodiments, the microspheres are introduced to the paper forming pulp in a slurry.

In some embodiments, sheets or labels may be coated with a thermoplastic material. In some of these embodiments, the thermoplastic material comprises microspheres. As mentioned above, an aqueous solution or dispersion comprising the microspheres and optionally a thermoplastic material may be applied to the sheet or label. While there are many suitable thermoplastic polymers which can be mixed with microspheres prior to applying microspheres to a sheet or label, one preferred thermoplastic material that can be used with microspheres is a Phenoxy-type thermoplastic material such as polyhydroxyaminoether (PHAE). Another suitable polymeric material that can be used with microspheres is a foam polymer, such as polypropylene. Such materials may be coated on a paper label substrate by the methods described herein or may be mixed with cellulose fibers or pulp prior to formation of the paper sheet or label. Alternatively, such materials may be coated on a label comprising one or more layers of polymeric material which may or may not include paper.

In some embodiments, microspheres may be mixed as a dispersion or emulsion with one or more organic carriers. While it is preferred that microspheres be dispersed with a carrier in water, other solvent systems and emulsion systems may be used. The solution or dispersion comprising microspheres and the organic carrier may be coated on the one or more layers of the sheets or labels. In some embodiments, the organic carrier may act as a functional material and provide function to the one or more layers comprising the functional material. Such carriers are further described herein.

In some embodiments, the solution or dispersion comprising microspheres and a carrier has a solid content of about 10 to about 90 weight percent of the aqueous solution or dispersion. In another embodiment, the solution or dispersion has a solid content of about 20 to about 60 weight percent. In another embodiment, the solution or dispersion has a solid content of about 30 to about 50 weight percent.

Upon application of a microsphere comprising material or after the formation of the paper comprising cellulose fibers, the sheet or label may be dried at a temperature at which the microspheres do not expand. In some embodiments, the microspheres do not expand at a temperature less than 120° C. In some embodiments, the microspheres do not expand at a temperature from about 30 to about 100° C. Conventional methods to accomplish such drying without expansion are known to persons having ordinary skill in the art. Additionally, the sheet or label may be flash dried utilizing IR radiation in conjunction with air flow to prevent overheating of the surface and/or expansion of the microspheres. In some embodiments, the IR radiation provides more uniform and controlled heating to prevent the microspheres from expanding while decreasing the drying time of the label or sheet.

In one embodiment, label stock may be coated according to methods discuss above in an aqueous solution or dispersion comprising microspheres. In some embodiments, the label stock may then be dried by methods described herein. Such label stock may then be rolled. In another embodiment, after drying of the label stock, the label stock may be cut into individual labels and applied to an article such as a container. The label may also be printed on prior to coating, after drying, prior to cutting or perforation, or after being applied to the article. In some embodiments, label stock or sheets may be perforated for cutting or tearing into labels.

In some embodiments, sheet or labels comprising microspheres may be exposed to a source of heat or pressure to expand the microspheres. In one preferred embodiment, sheets or labels may be heated by IR radiation. Another preferred heat source may be heated air. In some embodiments, a hot fill application may result in expansion of some microspheres. Under a heat source, at least some microspheres of the sheet or label may be expanded. In some embodiments, the heat source heats the sheet, label, or label stock on one or more sides. For example, label stock may be heated on the front or back sides, or both. In some embodiments, the heat applied is sufficient to expand a portion of the microspheres. In some embodiments, all of the microspheres are uniformly expanded. Controlled heating may cause localized expansion of at least some microspheres of the sheet or label. In one embodiment, localized heating may cause mold or design in the sheet or label as a relief mold or design.

In some embodiments, the volume of microspheres may be used to control the density and thickness of the label or sheet. As microspheres expand, the thickness and density of the one or more layers comprising microspheres will increase. As such, the thermal insulating ability of a label or sheet may be controlled through expansion of the microspheres.

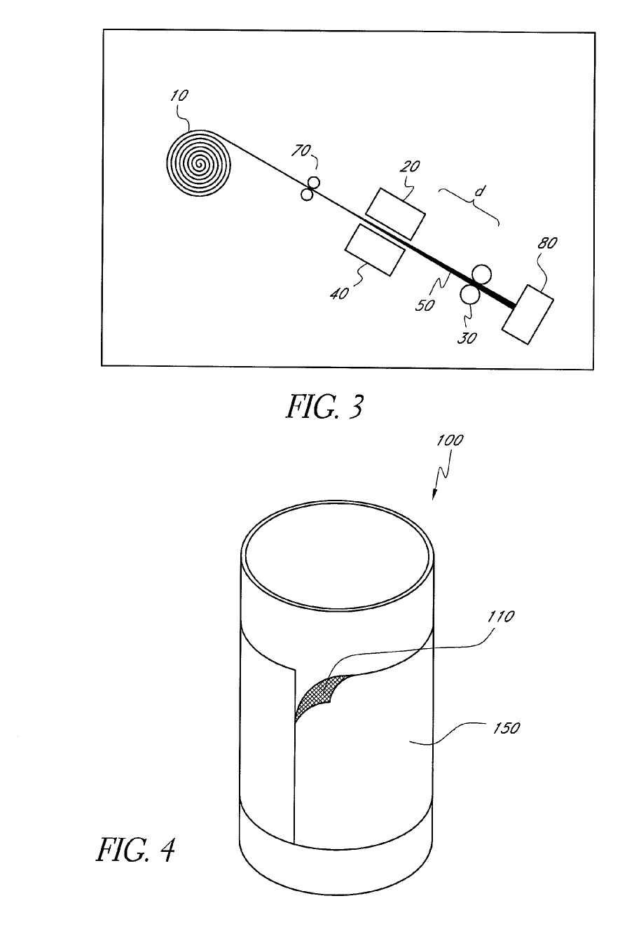

Referring to FIG. 3, label stock 10 comprising microspheres may be passed through one or more heaters 20 and/or 40 as described in FIG. 3. The degree of heat delivered to the label stock 10 by the system may control the expansion of the microspheres. In some embodiments, the label stock 10 comprising microspheres produces a foamed or expanded label stock 50. The label stock 10 may be printed on and/or applied to an article prior to or after expansion or foaming of the label stock 10. Articles which comprise these labels may also be subjected to a heat source (e.g., IR radiation) to produce a foamed or expanded label stock. Such labels or label stock may printed on prior to or after application of the label to an article. Additionally, the labels may be printed on prior to or after expansion of the microspheres.

In some embodiments, the label or sheet is exposed to heat on one side of the label or sheet. Referring to FIG. 3, one nonlimiting example allows label stock 10 to be heated by heater 20 on one side of the label stock. Alternatively, label stock 10 may be heated by heater 40 on the opposing side of the label stock. In some embodiments, label stock 10 is heated by both heaters 20 and 40. For example, in embodiments of labels comprising a foamed layer and a surface for printing, the foamed label or sheet may be selectively heated without exposing the printed or printable layer to heat. In other embodiments, the sheet or label may be heated on the top and bottom side of the label.

In one preferred method, label stock may be placed in a heating system 60. Pull rollers 30 may operate and pull the label stock 10 through one or more heaters 20 and 40. In some embodiments, rollers 30 may be chilled to cool the expanded label stock 50 and discontinue the expansion of the microspheres. In one particular embodiment, an optional upstream roller 70 may be heated. In another embodiment, one or more heaters 20 and 40, such as an IR radiation heater, may be used to heat the label stock 10. As the label stock 10 passes through the upstream roller 70 and one or more heaters 20 and 40, expansion of the microspheres occurs. Upon reaching a downstream roller 30 that is chilled, the expanded label stock 50 discontinues some or all expansion of the microspheres. In some embodiments, the distance d between the heating source, such as the one or more heaters 20 and 40 and a chilled downstream roller 30 may be varied to optimize and/or normalize the thickness of the expanded label stock 50. In some embodiments, a downstream roller 30 may also trim excess material from the expanded label stock 50.

In one particular embodiment, the expanded label stock 50 may be subjected to optional processor 80. Optional processor 80 may process label stock 50 including such processes as, but not limited to, one or more of the following: printing of the label stock 50, cutting of the expanded label stock 50, trimming of the expanded label stock 50, application of the expanded label stock 50 to articles, further expanding the expanded label stock 50. However, as will be understood by a person having ordinary skill in the art, these processes can take place at any time during the process and/or prior to expansion of the label stock 10.

In some embodiments, excess material may be trimmed during the process. Additionally, one or more rollers may exert pressure on the label stock as it passes through the one or more rollers. In one embodiment, an additional mold chamber may be provided to allow foaming and/or shaping of the label stock as it expands. Forming of the label stock can occur in any desired shape. In some embodiments, the label stock may be cut to form a label prior to application of the label to the container

In some embodiments, the sheet, label or label stock may be embossed. In some embodiments, a roller may be used to emboss indicia into the label or label stock. Embossing may occur prior to expansion of the microspheres, during expansion of the microspheres, or after expansion of the microspheres. In one embodiment, a roller may have a removable insert to change the design of the embossment received by the label or label stock. In some embodiments, the process of embossing the label or label stock may occur on the front side, back side, or both sides of the label stock. As such, the particular embossment may require a normal or inverse design or text. Additionally, a label may be embossed more than one time.

In some embodiments, the label or label stock may be printed. Label stock may be printed on prior to, during, or after expansion of the microspheres. Label stock may also be printed on prior to, during, or after embossing. Labels may be printed prior to, during, or after cutting of the label stock. Labels may also be printed prior to, during, or after application of the label to an article. Therefore, label stock or labels may be printed at any time prior to, during, or after the one or more processes.

In one particular embodiment, the ink of the indicia comprises microspheres. Upon expansion of these microspheres, the ink may provide a relief to the sheet or label comprising such ink. In some of these embodiments, the sheets or labels are printed prior to expansion of the microspheres. In another embodiment, the labels printed with ink comprising the microspheres may be applied to the bottle prior to expansion. However, as discussed herein, other orders of steps are foreseeable to those person having ordinary skill in the art.

In one embodiment, ink comprising microspheres may be selectively embossed by application of heat to cause at some portion of the microspheres to expand. In some embodiments, the microspheres cause substantial foaming of the label to create relief of at least some of the label. In some embodiments, in that portion of the label comprising microsphere-containing ink may create relief of the label in the portion. Such relief may be controlled by the expansion of the microspheres with means such as heat or pressure.

In some embodiments, the indicia which are printed on the sheet or label may comprise multiple colors. In some embodiments, the colors may be selectively embossed according to methods described herein. For example, certain colors comprising microspheres may be printed on the label. The microspheres of the certain colors may be expanded by heating of the colors comprising the microspheres, or in general, heating of the entire sheet or label to cause expansion of the microspheres. Other colors may or may not comprise microspheres. Different colors may be selected depending on the exact configuration desired.

In some embodiments, the labels are applied to one or more articles. As described above, the labels may be attached by any means to containers. In some embodiments, the labels may be attached to a container prior to, during, or after expansion of the microspheres. Additionally, labels may be attached to bottles prior to, during, or after printing of the labels. In some embodiments, the label stock may be attached to the bottles prior to cutting the label stock into labels. In some embodiments, the labels may be applied to unfilled, partially filed, or fully filled containers. Labels may also be printed prior to, during, or after filling of an article with solids, liquids, and/or gases.

Additionally, the label or label stock may be applied, printed, or embossed at any time during the process of container formation. For example, the label or label stock may be applied during the formation of the container, and subsequently printed prior to or after filling of the container. It will be understood by a person having ordinary skill in the art that may configurations and alternative embodiments and/or uses and obvious modifications to this process can be made such that the label may be applied, expanded, printed, or coated at any time during the process of container formation.

In one preferred embodiment, a label is printed after application to one or more containers. A system suitable for printing labels may include a machine that captures containers within individual chambers or pockets that orient and capture the container. The container may be spun in any direction, whether in the axis of the bottle or off axis, and along 360 degrees of rotation on any such axis. In these embodiments, the container may be printed prior to, during or after rotation of the container. Means of printing may included, but are not limited to, high speed printing devices such as laser, ink jet, roll, screen, ballistic, and other printing technologies.

In some embodiments, the label may be coated by one or more substrates prior to, during, or after the container formation process. In one nonlimiting example, a paper label is coated with one or more layers of microspheres and a carrier material. The label may be further coated with one or more layers of protective laminate. The containers may then be subjected to one or more processes in the manufacturing process (e.g., filling, or capping). Such a protective laminate may serve to protect the label from scuff or wear during one or more of the container manufacturing processes.

Sheets or label stock can be cut to form labels that can be applied to at least a portion of a container. Alternatively, the sheets can be used to form labels or packaging that are configured to cover substantially the entire surface area of a container to give superior insulating effect. In some embodiments, the labels can be sized and configured to cover at least 60%, 70%, 80%, 90%, 95%, and up to 100% of the surface area of packaging. In some embodiments, the labels can be sized to cover 100% of the container. For example, referring to FIG. 4, container 100 may be wrapped with sheet 150. Sheet 150 may comprise one or more layers. Adhesive layer 110 is shown and is capable of attaching sheet 150 to the container 100.

In some embodiments, the foam is corona or flame treated to enhance adhesion. Such surface modification may used to facilitate bonding to another surface with an adhesive layer. For example, in one embodiment, foam from an extrusion process can be passed through a corona or plasma discharge or flame treatment zone. In one embodiment, a OPP label can then be laminated on to the treated surface. In some embodiments, the treated surface is the article substrate. In some other embodiments, label graphics can be printed directly on the treated surface and then coated with an aqueous or extrusion coating. The coating preferably serves as a protective layer. Additionally, the coating preferably increases the tear resistance of the foam.

The skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. Additionally, the methods which is described and illustrated herein is not limited to the exact sequence of acts described, nor is it necessarily limited to the practice of all of the acts set forth. Other sequences of events or acts, or less than all of the events, or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein. Instead, Applicant intends that the scope of the invention be limited solely by reference to the attached claims, and that variations on the methods and materials disclosed herein which are apparent to those of skill in the art will fall within the scope of Applicant's invention.

What is claimed is:

1. A sheet comprising;
a first layer comprising microspheres;
a functional polymeric layer;
wherein the sheet is configured to contact a container.

2. The sheet of claim 1, wherein the layer comprising microspheres additionally comprises one or more carrier materials.

3. The sheet of claim 2, wherein the one or more carrier materials comprises polypropylene.

4. The sheet of claim 2, wherein the one or more carrier materials comprises cellulose material.

5. The sheet of claim 4, wherein the cellulose material comprises pulp.

6. The sheet of claim 4, wherein the cellulose material is paper.

7. The sheet of claim 1, wherein the sheet comprises at least one layer comprising paper, and wherein the at least one layer comprising paper is substantially free of microspheres.

8. A method of producing a foamed label comprising:
providing a plastic article substrate;
applying a label comprises microspheres to the plastic article substrate;
heating the label stock in a manner configured to expand at least some of the microspheres.

9. A method of forming a label comprising:
applying an aqueous solution or dispersion comprising an expandable material to the a substrate;
drying the solution or dispersion at a temperature that does not substantially cause expansion of the microspheres to form a layer on the substrate; and
cutting the substrate to produce one or more labels.

10. The method of claim 9, further comprising applying the one or more labels to a container.

11. The method of claim 9, further comprising printing the layer.
